(19) United States
(12) Patent Application Publication
(10) Pub. No.: US 2018/0364047 A1
(43) Pub. Date: Dec. 20, 2018

(54) ESTIMATION DEVICE, ESTIMATION METHOD, AND NON-TRANSITORY COMPUTER-READABLE RECORDING MEDIUM

(71) Applicant: YAHOO JAPAN CORPORATION, Tokyo (JP)

(72) Inventor: Munehiro AZAMI, Tokyo (JP)

(73) Assignee: YAHOO JAPAN CORPORATION, Tokyo (JP)

(21) Appl. No.: 15/913,518

(22) Filed: Mar. 6, 2018

(30) Foreign Application Priority Data
Jun. 15, 2017 (JP) 2017-117583

(51) Int. Cl. G01C 21/16; G01C 21/34; G01P 7/00

(52) U.S. Cl. CPC G01C 21/16; G01P 7/00; G01C 21/34

(57) ABSTRACT

An estimation device includes a detecting unit that detects acceleration; an acquiring unit that acquires a feature value that is based on the acceleration; and an estimation unit that estimates a speed based on a limit value of the feature value.

### CROSS-REFERENCE TO RELATED APPLICATION(S)

The present application claims priority to and incorporates by reference the entire contents of Japanese Patent Application No. 2017-117583 filed in Japan on Jun. 15, 2017.

### BACKGROUND OF THE INVENTION

### 1. Field of the Invention

The present invention relates to an estimation device, an estimation method, and a non-transitory computer-readable recording medium having stored therein an estimation program.

### 2. Description of the Related Art

Conventionally, there is a known technology of car navigation (hereinafter, also referred to as “navigation”) that navigates, to the destination, a vehicle driven by a user by using a portable terminal device, such as a smartphone. The terminal device that performs such the navigation specifies the current position of the vehicle by using a satellite positioning system, such as the Global Positioning System (GPS), and displays a screen indicating a map or a navigation route by superimposing the screen on the specified current position.

In contrast, the terminal device is not able to display the current position in a place, such as inside a tunnel, in which it is difficult to receive positioning signals from satellites. The same problem is not limited to the GPS and also commonly applies to positioning generally performed by using other positioning signals (for example, radio waves, wireless LAN radio waves, or the like from mobile phone (cellular) base stations). Thus, it is conceivable to use a technology of autonomous positioning that estimates the current position of a vehicle by using the acceleration measured by an accelerometer. For example, there is a proposed method for fixing a device having an accelerometer into a vehicle at a predetermined position and determining a running state of the vehicle based on the acceleration detected by the device (see Japanese Patent No. 4736866).

However, with the conventional technology described above, in some cases, the moving speed of a vehicle is not able to be accurately estimated. For example, in the conventional technology, due to an encounter of a traffic jam inside a tunnel, if a vehicle speed is greatly changed after the positioning signal is not able to be received, an estimated speed may sometimes become far apart from the actual speed.

### SUMMARY OF THE INVENTION

It is an object of the present invention to at least partially solve the problems in the conventional technology.

An estimation device includes a detecting unit that detects acceleration; an acquiring unit that acquires a feature value that is based on the acceleration; and an estimation unit that estimates a speed based on a limit value of the feature value.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of the operation and advantages exhibited by a terminal device according to an embodiment;

FIG. 2 is a diagram illustrating an example of a functional configuration of the terminal device according to the embodiment;

FIG. 3 is a diagram illustrating an example of information registered in a feature value database according to the embodiment;

FIG. 4 is a diagram illustrating an example of information registered in a speed range database according to the embodiment;

FIG. 5 is a diagram illustrating an example of information registered in a limit value database according to the embodiment;

FIG. 6 is a flowchart illustrating the flow of a navigation process performed by the terminal device according to the embodiment;

FIG. 7 is a flowchart illustrating the flow of a limit value update process performed by the terminal device according to the embodiment;

FIG. 8 is a scatter diagram in which feature values (Average_hor) based on the acceleration in the vertical direction with respect to the reference direction are plotted;

FIG. 9 is an enlarged view of the scatter diagram illustrated in FIG. 8;

FIG. 10 is a diagram illustrating a state in which the scatter diagram of plotted feature values is divided by the speed ranges;

FIG. 11 is a diagram illustrating a state in which limit values are plotted in each speed range;

FIG. 12 is a flowchart illustrating the flow of a limit value extraction process performed by the terminal device according to the embodiment;

FIG. 13 is a flowchart illustrating the flow of an estimation process performed by the terminal device according to the embodiment;

FIG. 14 is a diagram illustrating a state in which plotted limit values are connected by a line in a graph;

FIG. 15 is a graph illustrating an example different from that illustrated in FIG. 14;

FIG. 16 is a scatter diagram in which feature values (Stdev_hor) based on the acceleration in the vertical direction with respect to the reference direction are plotted;

FIG. 17 is a scatter diagram in which feature values (Max_hor) based on the acceleration in the vertical direction with respect to the reference direction are plotted;

FIG. 18 is a scatter diagram in which feature values (Stdev_ver) based on the acceleration in the reference direction are plotted;

FIG. 19 is a scatter diagram in which feature values (Max_ver) based on the acceleration in the reference direction are plotted;

FIG. 20 is a scatter diagram in which feature values (Min_ver) based on the acceleration in the reference direction are plotted;

FIG. 21 is a scatter diagram in which feature values (Min_hor) based on the acceleration in the vertical direction with respect to the reference direction are plotted;

FIG. 22 is a scatter diagram in which feature values (Average_ver) based on the acceleration in the reference direction are plotted; and

FIG. 23 is a hardware configuration diagram illustrating an example of a computer that implements the function of the terminal device.

### DETAILED DESCRIPTION OF THE PREFERRED EMBODIMENTS

A mode (hereinafter, referred to as an “embodiment”) for carrying out an estimation device, an estimation method, and a non-transitory computer-readable storage medium having stored therein an estimation program according to the present application will be described in detail below with reference to the accompanying drawings. The estimation device, the estimation method, and the estimation program according to the present application are not limited by the embodiment. Furthermore, in the embodiment below, the same components and processes are denoted by the same reference numerals and overlapping descriptions will be omitted.

Furthermore, in a description below, a description will be given of an example of, as a process performed by the estimation device, car navigation that navigates, to the destination, a vehicle driven by a user; however, the embodiment is not limited to this. For example, the estimation device may also perform the process described below even when a user is walking or using a means of transportation other than the vehicle, such as a train, and may also perform a process of the navigation the user to the destination.

### 1. Outline of Moving State

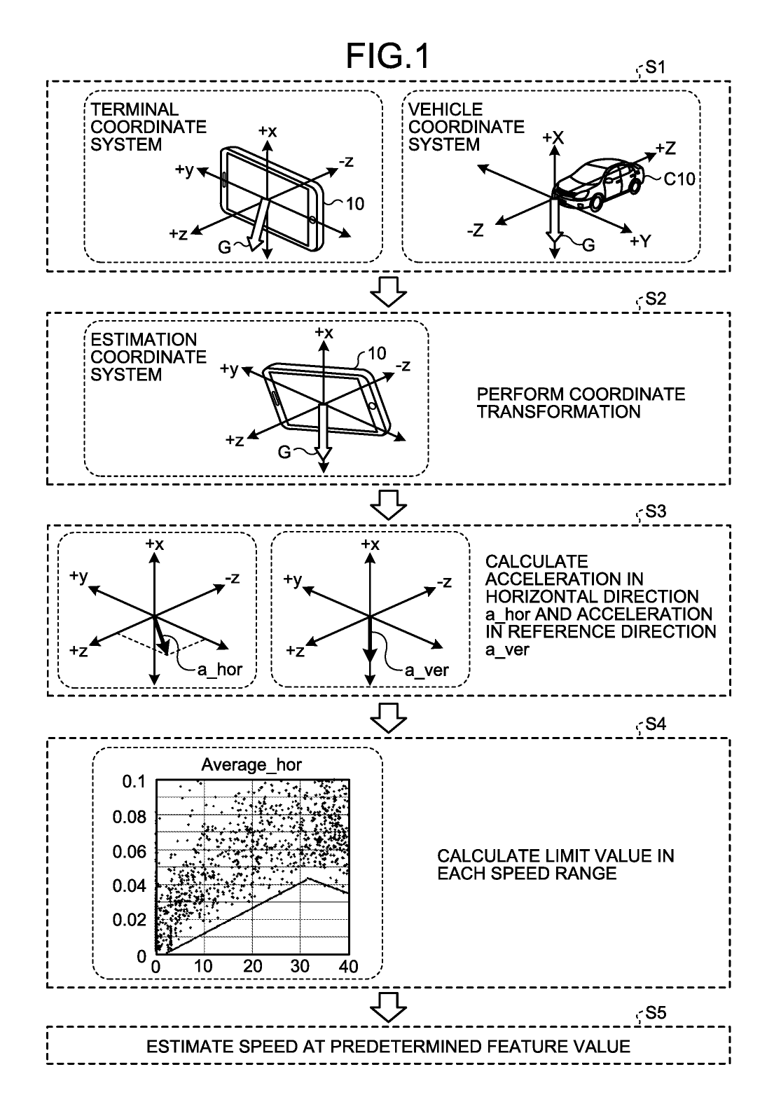

First, the concept of a moving mode determined by a terminal device 10 that is an example of an estimation device will be described with reference to FIG. 1. FIG. 1 is a diagram illustrating an example of the operation and advantages exhibited by a terminal device according to an embodiment. For example, the terminal device 10 is a mobile terminal, such as a smartphone, a tablet terminal, or a personal digital assistant (PDA), or a terminal device, such as a notebook personal computer (PC), and is a terminal device that can communicate with an arbitrary server via a network N, such as a mobile communication network or a wireless local area network (LAN).

Furthermore, the terminal device 10 has a function of car navigation that navigates a vehicle C10 driven by a user to the destination. For example, when the terminal device 10 receives an input of the destination from the user, the terminal device 10 acquires, from a server (not illustrated) or the like, route information that is used to navigate the user to the destination. For example, the route information includes information on a route to the destination that can be used by the vehicle C10, information on an expressway included in the route, traffic congestion information on the route, information on a facility that can be used as a landmark for the navigation, information on a map to be displayed on a screen, voice data or image data of a map output at the time of the navigation, or the like.

Furthermore, the terminal device 10 has a positioning function of specifying the position of the terminal device 10 (hereinafter, referred to as the “current position”) at predetermined time intervals by using positioning signals received from a satellite positioning system, such as the Global Positioning System (GPS). Then, the terminal device 10 displays an image of the map or the like included in the route information on a liquid crystal screen, an electroluminescent light emitting diode (LED) screen, or the like (hereinafter, simply referred to as a “screen”.) and displays the specified current position on the map each time. Furthermore, in accordance with the specified current position, the terminal device 10 displays a left turn, a right turn, a change in lane to be used, expected arrival time at the destination, and the like, or, alternatively outputs these pieces of information from a speaker or the like provided in the terminal device 10 or the vehicle C10.

Here, the satellite positioning system receives signals output from a plurality of satellites and specifies the current position of the terminal device 10 by using the received signals. Thus, in the place where the terminal device 10 is not able to appropriately receive the signals output from the satellites, such as in a tunnel or at the location between buildings, the terminal device 10 is not able to specify the current position. Furthermore, an application that allows the terminal device 10 to implement the navigation does not have a function of acquiring information on speeds, the moving direction, or the like from the vehicle C10. Consequently, it is conceivable to dispose an acceleration sensor that measures the acceleration of the terminal device 10 and estimates the present position of the terminal device 10 based on the acceleration measured by the acceleration sensor. For example, it is conceivable to perform an estimation process of estimating, based on the acceleration measured by the acceleration sensor, a moving speed, a moving direction, and the like of the terminal device 10 or perform stop determination that determines whether the terminal device 10 is moving or stopped.

A more specific example will be described. For example, if the terminal device 10 is not able to appropriately receive a signal output from a satellite, the terminal device 10 determines that the vehicle C10 enters a tunnel or the like and moves the estimated position forward in the moving direction at the vehicle speed specified last time. Furthermore, the terminal device 10 determines, based on the measured acceleration, whether the vehicle C10 is stopped and, if it is determined that the vehicle C10 is stopped, the terminal device 10 stops the estimated position from moving. In contrast, if the terminal device 10 determines that the vehicle C10 is not stopped, the terminal device 10 estimates, by using the measured acceleration, a moving speed of the vehicle C10 that is the moving object and continues the navigation assuming that the vehicle C10 is moving at the estimated moving speed.

### 1-1. Example of Speed Estimation Technology

Here, a description will be given of an example of a speed estimation technology of estimating a moving speed of the vehicle C10. The technology described here is an example of a technology prior to the present embodiments but does not belong to the original conventional technology. Namely, the technology described here is a technology secretly performed for development, examination, research, and the like by the applicant of the present application and is not a technology in which a secret is revealed, such as a technology that has become publicly known, used, or known to the public through publication.

For example, as indicated by a “terminal coordinate system” at Step S1 illustrated in FIG. 1, the terminal device 10 measures the acceleration in each of the x-, y-, and z-axis directions assuming that the direction of the short side of the screen is the x-axis, the direction of the long side of the screen is the y-axis, and the direction perpendicular to the screen is the z-axis. For example, the terminal device 10 measures the acceleration of the terminal coordinate system in each of the directions assuming that, when the screen corresponds to the front, the front surface side is the +z-axis direction and the back surface side is −z-axis, and assuming that, when the terminal device 10 is used, the upper side of the screen is the +x-axis direction, the back side of the screen is −x-axis direction, the left side of the screen is the +y-axis direction, and the right side of the screen is the −y-axis direction.

In contrast, as indicated by a “vehicle coordinate system” at Step S1 illustrated in FIG. 1, the moving direction or the speed of the vehicle C10 used by the user is represented by a vehicle coordinate system in which the direction in which the vehicle C10 is travelling is represented by Z-axis; on a plane perpendicular with respect to the Z-axis, the direction in which the vehicle C10 turns left or right at the time of travelling is represented by the Y-axis; and the vertical direction of the vehicle C10 is represented by the X-axis. For example, the moving direction or the speed of the vehicle C10 is represented by the vehicle coordinate system in which the upward direction of the vehicle C10 is represented by the +X-axis direction, the downward direction (i.e., the ground side) is represented by the −X-axis direction, the direction of a left turn is represented by the +Y-axis direction, the direction of a right turn is represented by the −Y-axis direction, the direction of the rear of the vehicle C10 is represented by the +Z-axis, and the direction of the front of the vehicle C10 is represented by the −Z-axis.

Here, the vehicle coordinate system and the terminal coordinate system have a difference in accordance with the installation position of the terminal device 10 or the like. Thus, the terminal device 10 estimates, by using, for example, the acceleration measured by the terminal coordinate system, the direction of gravitational force (G illustrated in FIG. 1), i.e., the −X-axis direction of the vehicle coordinate system; specifies the moving direction of the vehicle C10 by using distribution of the acceleration generated when the vehicle C10 increases or decreases in its speed or changes its moving direction; and obtains a rotation matrix that is used to transform the acceleration measured by the terminal coordinate system to the vehicle coordinate system based on the estimated reference direction and the moving direction. Then, the terminal device 10 transforms, by using the rotation matrix, the acceleration of the terminal coordinate system to the acceleration of the vehicle coordinate system and performs, by using the transformed acceleration, stop determination that determines whether the vehicle C10 is stopped or estimation of the moving speed of the vehicle C10.

For example, the terminal device 10 collects, as feature values, information on the amplitude, the frequency, the average value, the standard deviation, the maximum value, the minimum value, and the like in each of the axial direction of the transformed acceleration. Furthermore, regarding the feature values acquired when the speed of the vehicle C10 is equal to or greater than a predetermined threshold, the terminal device 10 accumulates the subject feature values as the feature values at the time of moving, whereas, regarding the feature values acquired when the speed of the vehicle C10 is equal to or less than a predetermined threshold, the terminal device 10 accumulates the subject feature values as the feature values at the time of being stopped.

Then, by using the accumulated feature values, the terminal device 10 learns a stop determination model that determines whether the vehicle C10 is stopped (for example, performed by a support vector machine (SVM) or the like) and determines, by using the learned stop determination model in a case where a satellite positioning system is not able to be used due to in a tunnel or the like, whether the vehicle C10 is stopped. Then, if the terminal device 10 determines that the vehicle C10 is not stopped, the terminal device 10 estimates the moving speed of the vehicle C10 based on, from among the acceleration acquired by the vehicle coordinate system, the integral value of the value of the acceleration on the surface of the moving direction.

However, with this technology, because it is difficult to accurately align the vehicle coordinate system with the terminal coordinate system due to the factor of an inclination or a corner of a road, there is a problem in that it is difficult to estimate the moving speed of a vehicle from the measured acceleration with high accuracy.

Furthermore, a user sometimes gets out of a vehicle by carrying the terminal device 10 in a service area or the like. Consequently, if the position of the terminal device 10 has been changed, the rotation matrix is accordingly changed; therefore, there is a need to again specify the traveling direction and again obtain the rotation matrix based on the specified traveling direction and the reference direction. However, even after having performed such processes, it is not able to perform stop determination of a vehicle and estimation of the moving speed of the vehicle until the traveling direction is specified. Furthermore, if a road is inclined or the traveling direction is changed at a corner or the like, because a difference is generated between the terminal coordinate system and the vehicle coordinate system, an error is easily generated in the determination result or the moving speed of the vehicle.

Furthermore, it is conceivable that the terminal device 10 continues the navigation with the assumption that the vehicle C10 is running at a constant speed at the time at which the GPS signal can be received (for example, at the time of entering a tunnel). However, in this case, if the vehicle speed is greatly changed, such as in a case of an encounter of a traffic jam inside a tunnel, an estimated speed may sometimes become far apart from the actual speed.

### 2. Process Performed by the Terminal Device 10 According to the Embodiment

Therefore, the terminal device 10 performs the following process. For example, the terminal device 10 detects the acceleration of a moving object, such as a vehicle C10, in which the terminal device 10 is disposed. Furthermore, the terminal device 10 acquires the feature value that is based on the acceleration and associates the speed range with the feature value. At this time, based on the speed judged from position information that is based on the positioning signal, the terminal device 10 may also judges the speed range that is to be associated with the feature value. Then, the terminal device 10 estimates the speed based on the limit value of the feature value. For example, if the terminal device 10 is not able to acquire the position information that is based on the positioning signal indicating inside a tunnel or the like, the terminal device 10 estimates the speed at a predetermined feature value based on the limit value (the upper limit or the lower limit) of the feature value. The limit value may also be a value in each speed range. Here, the predetermined feature value is the feature value calculated based on the acceleration acquired when, for example, the position information based on the positioning signal is not able to be acquired.

The terminal device 10 may also use an estimated speed (the “speed at a predetermined feature value”) as the moving speed itself of the moving object or the terminal device 10 or as a speed limiter (the maximum speed or the speed limit) of an estimated speed that is separately estimated. Furthermore, the estimated speed that is separately estimated may also be a constant speed (for example, the speed at the time of entering a tunnel) or may also be a speed estimated from the acceleration by using a learning model, such as SVMs.

In the following, an example of the functional configuration and the operation and advantages of the terminal device 10 that implements the above described process will be described.

### 2-1. Example of Functional Configuration

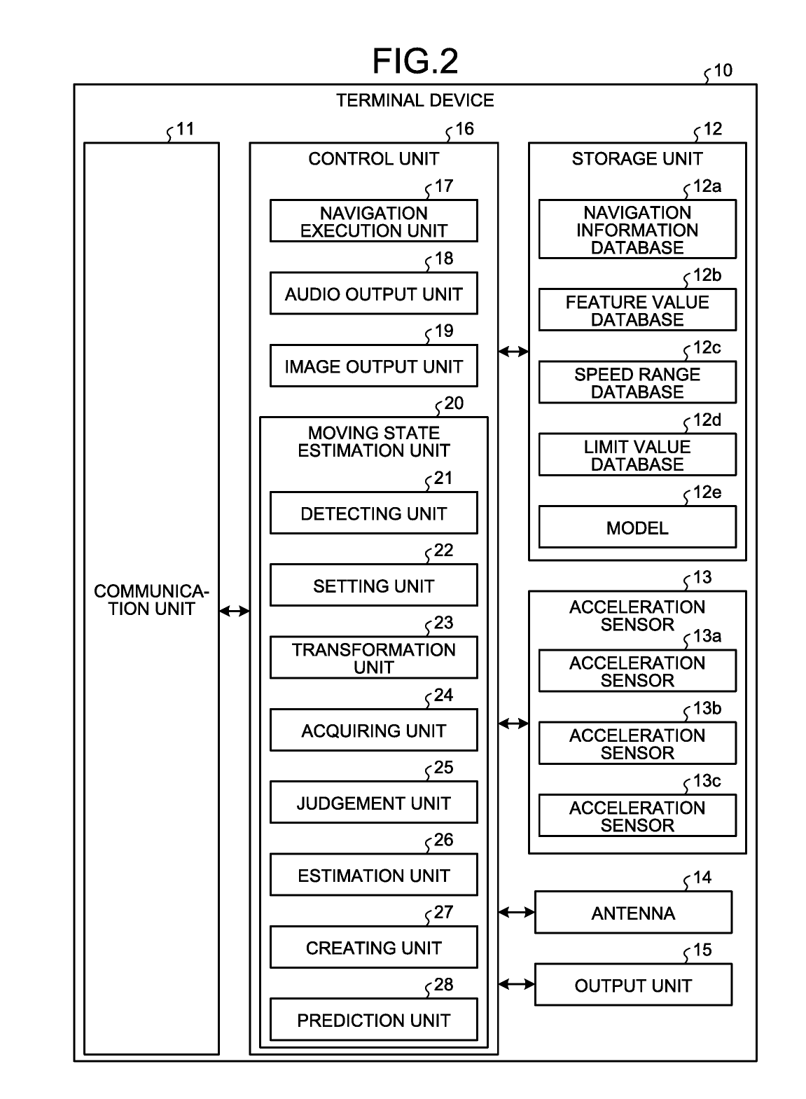

FIG. 2 is a diagram illustrating an example of a functional configuration of the terminal device according to the embodiment. As illustrated in FIG. 2, the terminal device 10 includes a communication unit 11, a storage unit 12, a plurality of acceleration sensors 13a to 13c (hereinafter, sometimes collectively referred to as an “acceleration sensor 13”), an antenna 14, an output unit 15, and a control unit 16. The communication unit 11 is implemented by, for example, a network interface card (NIC), or the like. Then, the communication unit 11 is connected to the network N in a wired or wireless manner and, when the communication unit 11 receives the destination from the terminal device 10, sends and receives information between the terminal device 10 and a distribution server that distributes route information indicating the route to the destination.

The storage unit 12 is implemented by, for example, a semiconductor memory device, such as a random access memory (RAM), a flash memory, or a storage device, such as a hard disk or an optical disk. The storage unit 12 stores therein various kinds of data that are used to execute the navigation. For example, the storage unit 12 stores therein data, such as a navigation information database 12a, a feature value database 12b, a speed range database 12c, a limit value database 12d, and a model 12e.

In the navigation information database 12a, various kinds of data that are used when the terminal device 10 gives the navigation are registered. For example, the navigation information database 12a stores therein the route information indicating the way to the destination received from a server (not illustrated) or the like. Furthermore, the navigation information database 12a stores therein various kinds of images, audio data, or the like output at the time of the navigation.

In the feature value database 12b, the feature values acquired by the terminal device 10 are registered. Specifically, in the feature value database 12b, data obtained by associating feature values calculated based on the acceleration detected by the acceleration sensor 13 with the moving speeds at the time of collecting the subject feature values is registered.

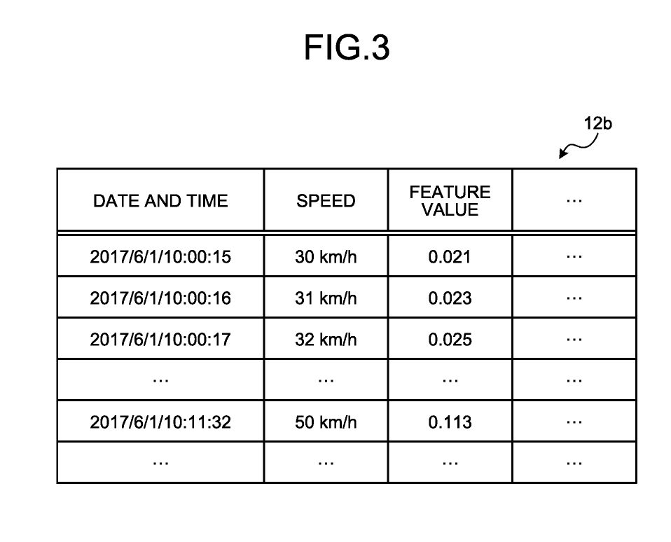

FIG. 3 is a diagram illustrating an example of information registered in the feature value database 12b according to the embodiment. As illustrated in FIG. 3, in the feature value database 12b, information having items, such as “date and time”, “speed”, “feature value”, and the like, is registered. The “date and time” is the date and time at which the subject feature value was collected and is information indicating, for example, “2017/6/1/10:00:15”. The “speed” is a speed at the time of collecting the subject feature value and is information indicating, for example, “30 km/h” or the like. The “feature value” is a value calculated based on the acceleration detected by the acceleration sensor 13 and is the average of, for example, the components of the acceleration in the direction of gravitational force in a predetermined period (for example, one second). In the example illustrated in FIG. 3, data, such as that indicated by “0.021”, corresponds to the feature value. The feature value will be described later. The feature value database 12b is used in a limit value update process, which will be described later.

The speed range database 12c stores therein feature values included in each of the speed ranges. The speed range database 12c is used as a work space for calculating a limit value in the limit value extraction process, which will be described later. In the speed range database 12c, an area that stores therein a plurality of feature values is prepared in each speed range.

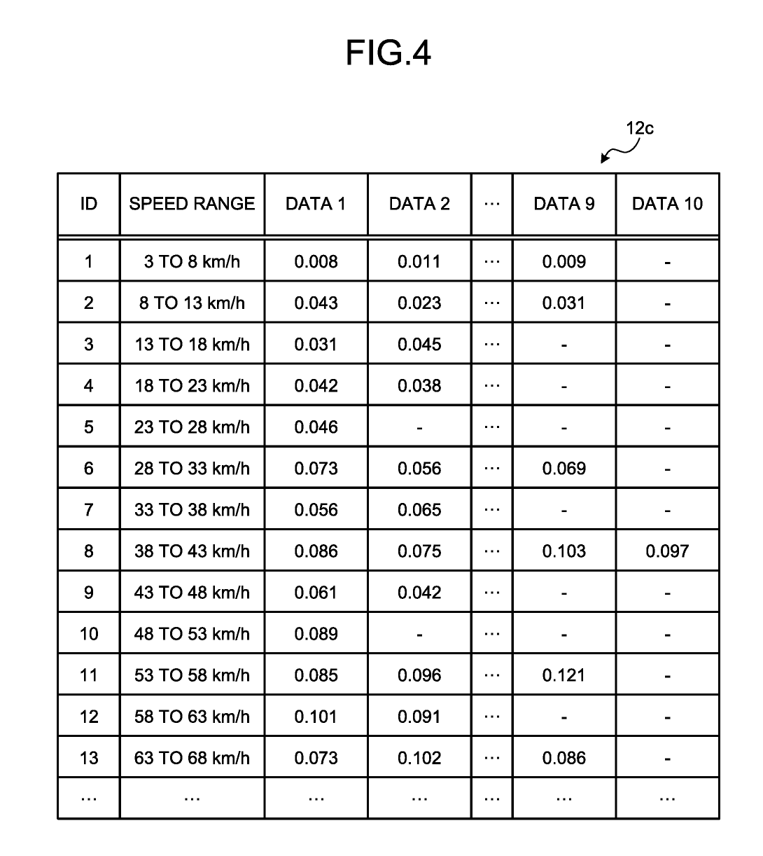

FIG. 4 is a diagram illustrating an example of information registered in the speed range database 12c according to the embodiment. As illustrated in FIG. 4, in the speed range database 12c, information having items, such as “ID”, “speed range”, and “data 1” to “data 10”, is registered. The “ID” is identification number attached to each of the speed ranges. The “speed range” is information indicating the speed range to which the moving speed of the terminal device 10 at the time of acquiring the feature value belongs. In the example illustrated in FIG. 4, the interval of the “speed range” is 5 km/h, such as 3-8 km, 8-13 km/h, and the like. Furthermore, the interval of the speed range is not limited to 5 km/h. The interval of the speed range may also be greater or smaller than 5 km/h. The speed range is the concept including speeds. Namely, if the interval of the speed range is made small, a speed is obtained. Furthermore, the “data 1” to the “data 10” are the work space for calculating a limit value in the limit value extraction process, which will be described later. A single feature value is stored in a single piece of data area. In the example illustrated in FIG. 4, ten feature values can be stored in a single speed range.

The limit value database 12d stores therein the limit value in each speed range. The limit value is a value of the upper limit or the lower limit of the feature value appearing in each of the speed ranges from among the plurality of feature values acquired by the terminal device 10. The limit value is acquired in the limit value extraction process, which will be described later, and is registered in the limit value database 12d.

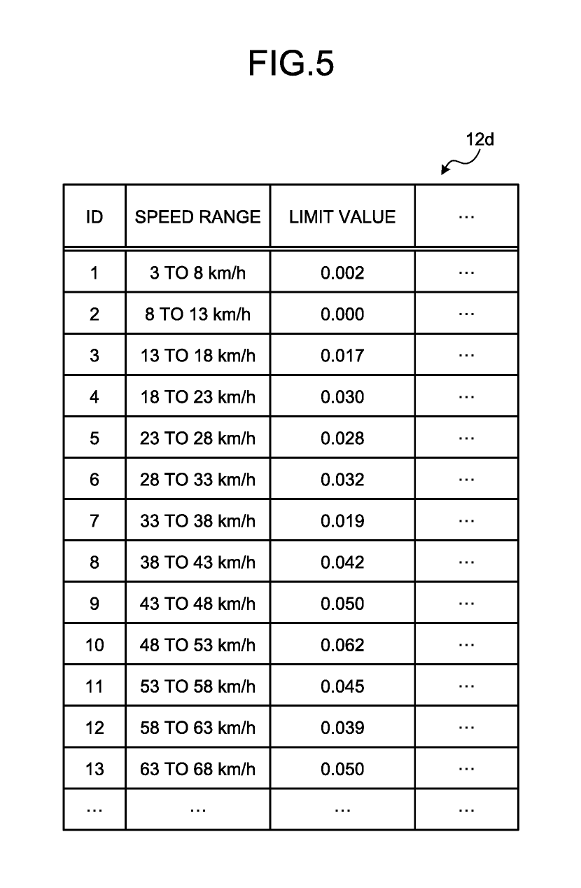

FIG. 5 is a diagram illustrating an example of information registered in the limit value database 12d according to the embodiment. As illustrated in FIG. 5, in the limit value database 12d, information having items, such as “ID”, “speed range”, “limit value”, and the like, are registered. The “ID” is the identification number attached to each of the speed ranges. The “speed range” is information indicating the speed range to which the moving speed of the terminal device 10 at the time of acquiring the feature value that was based on the limit value belongs. The “limit value” is a limit value acquired in the limit value extraction process, which will be described later.

The model 12e stores therein, if the terminal device 10 is not able to acquire the position information that is based on the positioning signal, data (learning model) that is used by the terminal device 10 to calculate the speed (the maximum speed) of the moving object or the terminal device 10. For example, the model 12e is data obtained by associating the limit value with the speed range (including a speed). Furthermore, the model 12e includes an input layer in which an acceleration acquired by the acceleration sensor 13 or a feature value that is based on the acceleration is input, an output layer, a first element belonging to one of the layers that is present between the input layer and the output layer and that is other than the output layer, and a second element in which a value is calculated based on the first element and the weight of the first element. The terminal device 10 may also be functioned such that the speed (the maximum speed) of the moving object or the terminal device 10 is output from the output layer in accordance with the acceleration that is input to the input layer or the feature value that is based on the acceleration. At this time, the first element is the acceleration or the feature value that is based on the acceleration, whereas the second element is the speed (the maximum speed) of the moving object or the terminal device 10. The weight may also be, for example, the data based on the limit value.

Here, it is assumed that the model 12e is implemented by a regression model indicated by “y=a1*x1+a2*x2+ . . . +ai*xi”. In this case, the first element included in the model 12e is associated with the input data (xi), such as x1 and x2. Furthermore, the weight of the first element is associated with a coefficient ai associated with xi. Here, the regression model can be considered as a simple perceptron having an input layer and an output layer. If each of the models is considered as the simple perceptron, the first element is considered to be associated with one of the nodes included in the input layer and the second element is considered as the node included in the output layer.

Furthermore, it is assumed that the model 12e is implemented by a neural network, such as a deep neural network (DNN), that has one or more intermediate layers. In this case, the first element included in the model 12e is associated with one of the nodes included in the input layer or the intermediate layer. Furthermore, the second element is associated with the subsequent node that is the node to which a value is transferred from the node associated with the first element. Furthermore, the weight of the first element is associated with a connection coefficient that is the weight considered with respect to the value that is transferred from the node associated with the first element to the node associated with the second element.

The terminal device 10 calculates the speed (the maximum speed) of the terminal device 10 by using the model, such as a regression model or a neural network, that has an arbitrary structure. Specifically, if the acceleration that is acquired by the acceleration sensor 13 or the feature value that is based on the acceleration is input, a coefficient is set in the model 12e, such that the speed (the maximum speed) of the moving object or the terminal device 10 is output. The terminal device 10 calculates the speed (the maximum speed) of the moving object or the terminal device 10 by using the above described model 12e.

The example described above indicates an example of the model 12e that is a model (hereinafter, referred to as a model X) that outputs, when the acceleration acquired by the acceleration sensor 13 or the feature value based on the acceleration is input, the speed (the maximum speed) of the moving object or the terminal device 10. However, the model 12e according to the embodiment may also be a model that is created based on the result that is obtained by repeatedly inputting and outputting data to and from the model X. For example, the model 12e may also be a model (hereinafter, referred to as a model Y) in which learning has been performed such that the acceleration acquired by the acceleration sensor 13 or the feature value that is based on the acceleration is to be input and the speed (the maximum speed) of the moving object or the terminal device 10 output by the model X is to be output. Alternatively, the model 12e may also be a model in which learning has been performed such that the acceleration acquired by the acceleration sensor 13 or the feature value that is based on the acceleration is to be input and the output value of the model Y is to be output.

Furthermore, if the terminal device 10 performs the estimation process using Generative Adversarial Networks (GANs), the model 12e may also be a model that constitutes a part of the GANs. Furthermore, the model 12e may also be data having the same structure as that of the limit value database 12d.

A description will be continued by referring back to FIG. 2. The acceleration sensor 13 measures, at predetermined time intervals, the magnitude and the direction of the acceleration related to the terminal device 10. For example, the acceleration sensor 13a measures the acceleration in the x-axis direction in the terminal coordinate system. The acceleration sensor 13b measures the acceleration in the y-axis direction in the terminal coordinate system. The acceleration sensor 13c measures the acceleration in the z-axis direction in the terminal coordinate system. Namely, by using the acceleration measured by each of the acceleration sensors 13a to 13c as the acceleration in each of the axial directions in the terminal coordinate system, the terminal device 10 can acquire the vector that indicates the direction and the magnitude of the acceleration with respect to the terminal device 10.

The antenna 14 is an antenna for receiving positioning signal used in the satellite positioning system, such as the GPS, from satellites. The output unit 15 is a screen used to display a map or the current position or a speaker used to output a voice at the time of giving the navigation. Furthermore, each of the acceleration sensor 13 and the antenna 14 is implemented by predetermined hardware.

The control unit 16 is a controller and is implemented by, for example, a processor, such as a central processing unit (CPU), a micro processing unit (MPU), or the like, executing various kinds of programs, which are stored in a storage device in the terminal device 10, by using a RAM or the like as a work area. Furthermore, the control unit 16 is a controller and may also be implemented by, for example, an integrated circuit, such as an application specific integrated circuit (ASIC), a field programmable gate array (FPGA), or the like. In the example illustrated in FIG. 2, the control unit 16 includes a navigation execution unit 17, an audio output unit 18, an image output unit 19, and a moving state estimation unit 20 (hereinafter, sometimes collectively referred to as each of the processing units). Furthermore, the moving state estimation unit 20 includes a detecting unit 21, a setting unit 22, a transformation unit 23, an acquiring unit 24, a judgement unit 25, and an estimation unit 26.

Furthermore, the moving state estimation unit 20 includes a creating unit 27 and a prediction unit 28. The creating unit 27 creates the model 12e and stores the created model 12e in the storage unit 12. For example, the creating unit 27 creates data obtained by associating, based on the acceleration or the feature value that is based on the acceleration and based on the speed of the moving object or the terminal device 10 at the time of acquiring the subject acceleration, the speed range with the limit value. Furthermore, the creating unit 27 may also create the model 12e by using any learning algorithms. For example, the creating unit 27 creates the model 12e by using the learning algorithm, such as neural networks, support vector machines, clustering, and reinforcement learning. As an example, if the creating unit 27 creates the model 12e by using a neural network, the model 12e has an input layer that includes one or more neurons, an intermediate layer that includes one or more neurons, and an output layer that includes one or more neurons.

The prediction unit 28 predicts the speed (the maximum speed) of the moving object or the terminal device 10 in a case where the position information based on the positioning signal is not able to be acquired. For example, the prediction unit 28 inputs, in information processing performed in accordance with the model 12e, the acceleration or the feature value that is based on the acceleration to the input layer. Then, by propagating the input data to the intermediate layer and the output layer, the prediction unit 28 outputs the speed (the maximum speed) of the moving object or the terminal device 10 from the output layer.

Furthermore, each of the processing units (the navigation execution unit 17 to the moving state estimation unit 20) included in the control unit 16 implements and executes the function and the operation of the navigation process described below (for example FIG. 1); however, the processing units are the functional units arranged for a description and do not need to be matched with the actual hardware elements or software modules. Namely, the terminal device 10 may implement or execute the navigation process in any functional units as long as the function and the operation of the navigation process described below can be implemented and executed.

### 2-2. Example of Operation and Advantages in Navigation Process

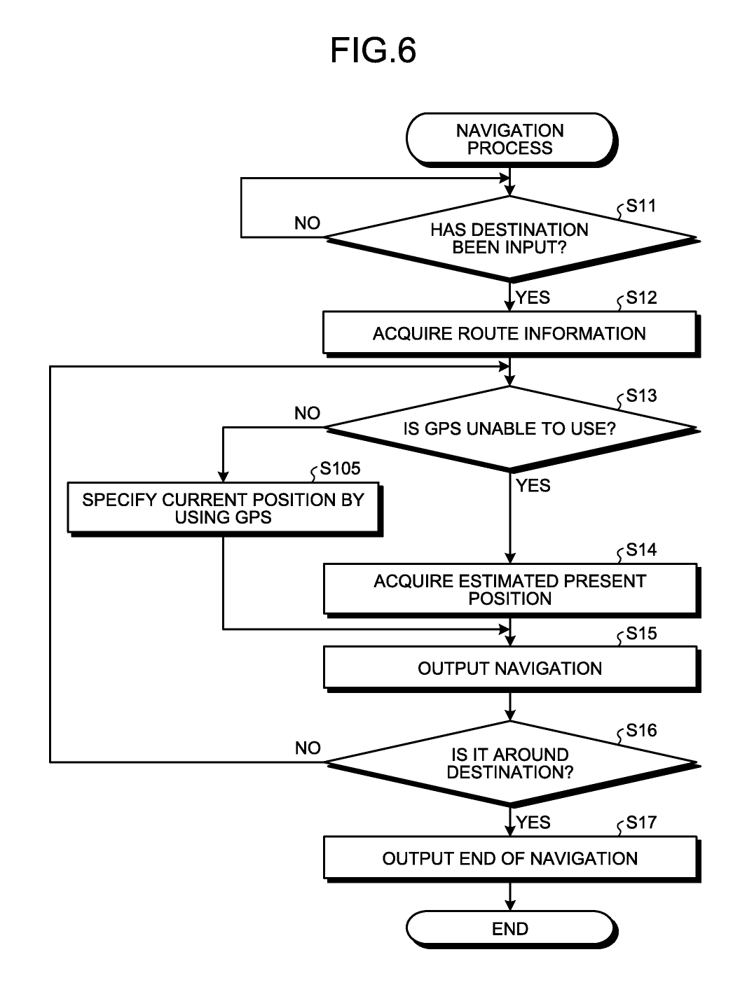

In the following, content of the navigation process executed and implemented by each of the processing units (the navigation execution unit 17 to the moving state estimation unit 20) will be described by using the flowchart illustrated in FIG. 6. FIG. 6 is a flowchart illustrating the flow of a navigation process performed by the terminal device according to the embodiment.

First, the navigation execution unit 17 determines whether the destination has been input from a user (Step S11). Then, if the destination has been input (Yes at Step S11), the navigation execution unit 17 acquires the route information from an external server (not illustrated in the drawing) (Step S12). At the time, the navigation execution unit 17 determines whether the GPS can be used (Step S13).

For example, if the antenna 14 is not able to receive a positioning signal from a satellite or if the number of satellites that was able to receive the positioning signals is less than a predetermined threshold, the navigation execution unit 17 determines that the GPS is not able to be used (Yes at Step S13), the navigation execution unit 17 acquires the present position (position information) based on the moving direction or the speed of the vehicle estimated by the moving state estimation unit 20 (Step S14). For example, the navigation execution unit 17 acquires the current position estimated by the moving state estimation unit 20. Furthermore, specific content of the process of estimating the current position of the vehicle C10 performed by the moving state estimation unit 20 will be described later.

In contrast, if the navigation execution unit 17 determines that the GPS can be used (No at Step S13), the navigation execution unit 17 specifies the current position by using the GPS (Step S105). Then, the navigation execution unit 17 controls the audio output unit 18 and the image output unit 19 and then outputs the navigation by using the current position obtained from the GPS or by using the estimated current position (Step S15). For example, in accordance with the control from the navigation execution unit 17, the audio output unit 18 outputs, from the output unit 15, the current position, the direction in which the vehicle C10 needs to move. Furthermore, in accordance with the control received from the navigation execution unit 17, the image output unit 19 outputs, from the output unit 15, the image in which the current position is superimposed on a map of the surrounding area or the image that indicates the direction in which the vehicle C10 needs to move.

Subsequently, the navigation execution unit 17 determines whether the current position is the area around the destination (Step S16). Then, if the navigation execution unit 17 determines that the current position is the area around the destination (Yes at Step S16), the navigation execution unit 17 controls the audio output unit 18 and the image output unit 19, outputs end the navigation indicating the end of the navigation (Step S17), and ends the process. In contrast, if the navigation execution unit 17 determines that the current position is not the area around the destination (No at Step S16), the navigation execution unit 17 performs the process at Step S13. Furthermore, if the destination has not been input (No at Step S11), the navigation execution unit 17 waits until the navigation execution unit 17 receive an input.

### 2-3. Example of Operation and Advantages in Limit Value Update Process

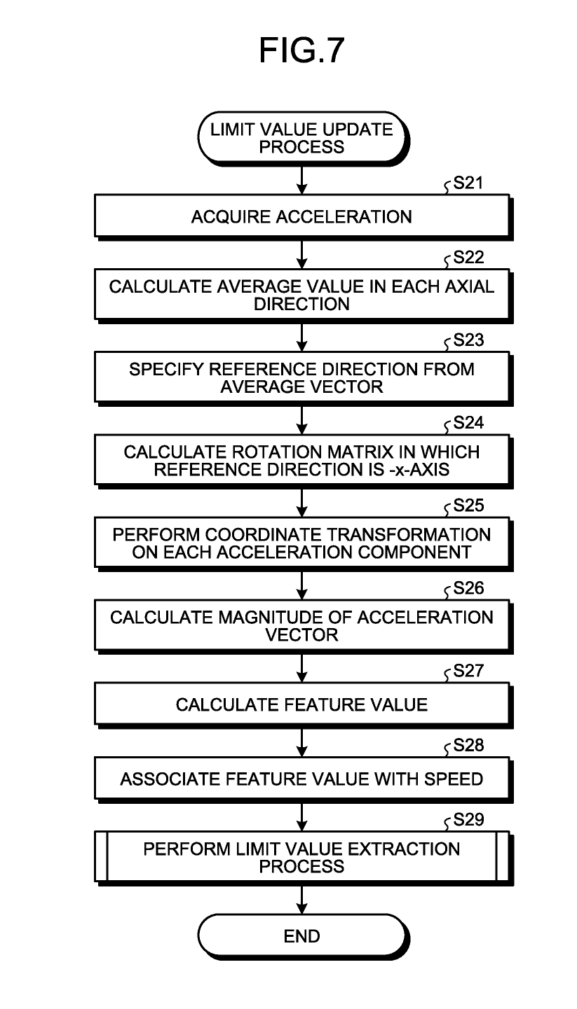

In the following, content of the limit value update process executed and implemented by the detecting unit 21, the setting unit 22, the transformation unit 23, the acquiring unit 24, and the judgement unit 25 will be described by using the flowchart illustrated in FIG. 7. FIG. 7 is a flowchart illustrating the flow of the limit value update process performed by the terminal device according to the embodiment. Furthermore, the detecting unit 21, the setting unit 22, the transformation unit 23, the acquiring unit 24, and the judgement unit 25 execute the limit value update process illustrated in FIG. 7 in each of a predetermined period (for example, one second). The limit value update process is performed when, for example, the position information based on the positioning signal can be acquired. Each of the processes illustrated in FIG. 7 is associated with the process indicated by, for example, Step S1 to Step S4 illustrated in FIG. 1.

First, the detecting unit 21 acquires the acceleration from the acceleration sensor 13 (Step S21). Specifically, the acceleration sensor 13 acquires, at predetermined time intervals, the magnitude of the acceleration measured in the axial directions (x, y, and z) of the terminal coordinate system. Furthermore, the detecting unit 21 calculates, in each of the axial directions of the terminal coordinate system, the average value of the magnitudes of the acceleration measured by the acceleration sensor 13 in a predetermined period (Step S22). For example, the detecting unit 21 collects, for one second, the acceleration of the terminal coordinate system detected by the acceleration sensor 13 at an interval of 20 millisecond (i.e., at the rate of 50 times per one second). Then, the detecting unit 21 calculates each of the average value xₘ of the values of the collected acceleration in the x-axis direction, the average value yₘ of the values in the y-axis direction, and the average value zₘ of the values in the z-axis direction and sets the vector (xₘ, yₘ, and zₘ) constituted from the calculated average value in each of the axial directions to the average vector G. In order to align, with high accuracy, the direction of the average vector G with the direction of gravitational force, the detecting unit 21 may also collect the acceleration of the terminal coordinate system for a period longer than one second (for example, one second to one minute).

Furthermore, the direction of the average vector G substantially matches the direction of the gravitational acceleration when a vehicle is stopped or a vehicle is moving at a constant speed. In order to align, with high accuracy, the direction of the average vector G with the direction of gravitational force, the detecting unit 21 determines, based on the positioning signal or the like, whether the vehicle is stopped or the vehicle is moving at a constant speed and may also set, to the average vector G, the vector (xm, ym, zm) formed of the average value in each of the axial directions in a case where the vehicle is stopped or the vehicle is moving at a constant speed. Furthermore, whether or not the vehicle is stopped or the vehicle is moving at a constant speed can also be determined by using a learning model. For example, the terminal device 10 learns, based on the feature value that is based on the acceleration and based on the GPS speed, a stop determination model that is used to determine whether a vehicle is stopped or a speed estimation model that is used to estimate the speed range of the movement of the vehicle. Then, by using the stop determination model or the speed estimation model, the terminal device 10 determines whether the vehicle is stopped or the vehicle is moving at a constant speed.

Subsequently, the setting unit 22 specifies the reference direction based on the acceleration calculated by the detecting unit 21. For example, the setting unit 22 specifies the reference direction from the average vector of the acceleration (Step S23). More specifically, the setting unit 22 sets the direction of the average vector G constituted from the average value of the acceleration calculated by the detecting unit 21 to the reference direction. Then, the transformation unit 23 calculates the rotation matrix that is used to match a predetermined axial direction of the terminal coordinate system with the reference direction that has been set by the setting unit (Step S24). Then, the transformation unit 23 transforms, by using the calculated rotation matrix, each of the components of the acceleration acquired from the terminal coordinate system by the detecting unit 21 (Step S25). Namely, the transformation unit 23 transforms the acceleration acquired by the detecting unit 21 to the acceleration of the coordinate system, instead of the vehicle coordinate system, that uses the reference direction as the reference.

For example, the setting unit 22 sets the direction of the average vector G of the acceleration as the reference direction. Then, as indicated by Step S2 illustrated in FIG. 1, the transformation unit 23 calculates the rotation matrix in which the −x-axis direction of the terminal coordinate system and the direction of the average vector G match. As described above, if, for example, the vehicle C10 is stopped, it is predicted that the direction of the average vector G matches the direction of the gravitational acceleration. Thus, by allowing the direction of the −x-axis of the terminal coordinate system to match the direction of the average vector G, the transformation unit 23 allows the direction of the −x-axis of the terminal coordinate system to match the direction of the X-axis of the vehicle coordinate system.

Furthermore, the transformation unit 23 may also determine, by using the SVM, the GPS speed, or the like, whether the vehicle C10 is stopped and set, if it is determined that the vehicle C10 is stopped, the direction of the average vector G of the acceleration acquired by the acceleration sensor 13 to the reference direction. Furthermore, if the rotation matrix is the matrix in which the direction of the −x-axis of the terminal coordinate system matches the direction of the average vector G, the transformation unit 23 may also use an arbitrary rotation matrix. Namely, the transformation unit 23 may use the rotation matrix that is used to rotate the y-axis direction or the z-axis direction to an arbitrary direction.

Then, the transformation unit 23 transforms, by using the calculated rotation matrix, the acceleration measured by the terminal coordinate system to the coordinate system in which the average value of the acceleration is used as a reference (hereinafter, referred to as an estimation coordinate system). Furthermore, in a description below, the direction of the average vector G in the estimation coordinate system is set to the −x-axis direction. Furthermore, in a description below, the −x-axis direction of the estimation coordinate system is sometimes referred to as the reference direction.

Subsequently, the acquiring unit 24 calculates the magnitude of the acceleration vector based on the acceleration acquired by the detecting unit 21 (Step S26). At this time, the magnitude of the acceleration vector calculated by the acquiring unit 24 is the magnitude of the component of the direction of the average vector G of the acceleration acquired by the detecting unit 21 (the acceleration vector of the direction of the average vector G) and the magnitude of the component of the vertical direction with respect to the direction of the average vector G (the acceleration vector in the vertical direction with respect to the direction of the average vector G). The direction of the average vector G is the x-axis direction of the estimation coordinate system and the vertical direction with respect to the direction of the average vector G is the direction along a vertical plane with respect to the average vector G (hereinafter, referred to as a horizontal plane). The acquiring unit 24 may also calculate the acceleration vector for each of the pieces of acceleration, measured by the acceleration sensor 13, obtained in a predetermined period of time (for example, one second) a predetermined number of times (for example, 50 times).

Then, the acquiring unit 24 calculates the feature value based on the magnitude of the acceleration vector calculated at Step S26 (Step S27). The acquiring unit 24 may also calculate the value based on the acceleration in the reference direction as the feature value or may also calculate the value based on the acceleration in the vertical direction with respect to the reference direction as the feature value. For example, the acquiring unit 24 calculates the feature value as follows.

First, from among each of the axial components of the acceleration subjected to a coordinate transformation performed by the transformation unit 23, the acquiring unit 24 obtains the magnitude of the acceleration in the direction of the average vector G and the magnitude of the acceleration on the horizontal plane. Namely, as indicated by Step S3 illustrated in FIG. 1, the acquiring unit 24 obtains the magnitude of the acceleration in the reference direction “a_ver” of the estimation coordinate system and the magnitude of the acceleration in the vertical direction with respect to the reference direction “a_hor”. More specifically, if the components of the acceleration of the estimation coordinate system are represented by “a_x, a_y, and a_z”, the acquiring unit 24 calculates the value obtained by multiplying −1 by the component “a_x” as “a_ver” and calculates the value of the square root of the sum of the square of the component “a_y” and the square of the component “a_z” as “a_hor”.

Then, the acquiring unit 24 calculates the average value, the standard deviation, the maximum value, and the minimum value of each of the calculated “a_hor” and “a_ver” in a predetermined period (for example, one second) or a predetermined number of times (for example, 50 times). The acquiring unit 24 acquires at least one of the eight types of values (the average value, the standard deviation, the maximum value, and the minimum value of a_hor and the average value, the standard deviation, the maximum value, and the minimum value of a_ver) as the feature value. Furthermore, as described later, the six types of values, i.e., the average value, the standard deviation, and the maximum value of a_hor and the standard deviation, the maximum value, and the minimum value of a_ver, are preferable for the feature value. In a description below, as an example, it is assumed that the acquiring unit 24 acquires the average value of a_hor (hereinafter, also referred to as Average_hor) as the feature value.

Subsequently, the acquiring unit 24 associates the feature value calculated at Step S27 with a speed (Step S28). The speed associated with the feature value may also be the speed based on the position information that is determined from the positioning signal. For example, the speed associated with the feature value may also be the GPS speed. The acquiring unit 24 associates the feature value with the speed and registers the associated data in the feature value database 12b. As illustrated in FIG. 3, the information on the date and time on which the feature value was acquired may also be associated with the combination of the feature value and the speed.

Subsequently, the judgement unit 25 performs the limit value extraction process (Step S29). The limit value extraction process is a process of extracting, in each speed range, the limit value of the feature value. The judgement unit 25 judges the limit value in a predetermined speed range (measured speed range) based on the information on the feature value that is associated with the speed range.

### 2-4. Limit Value

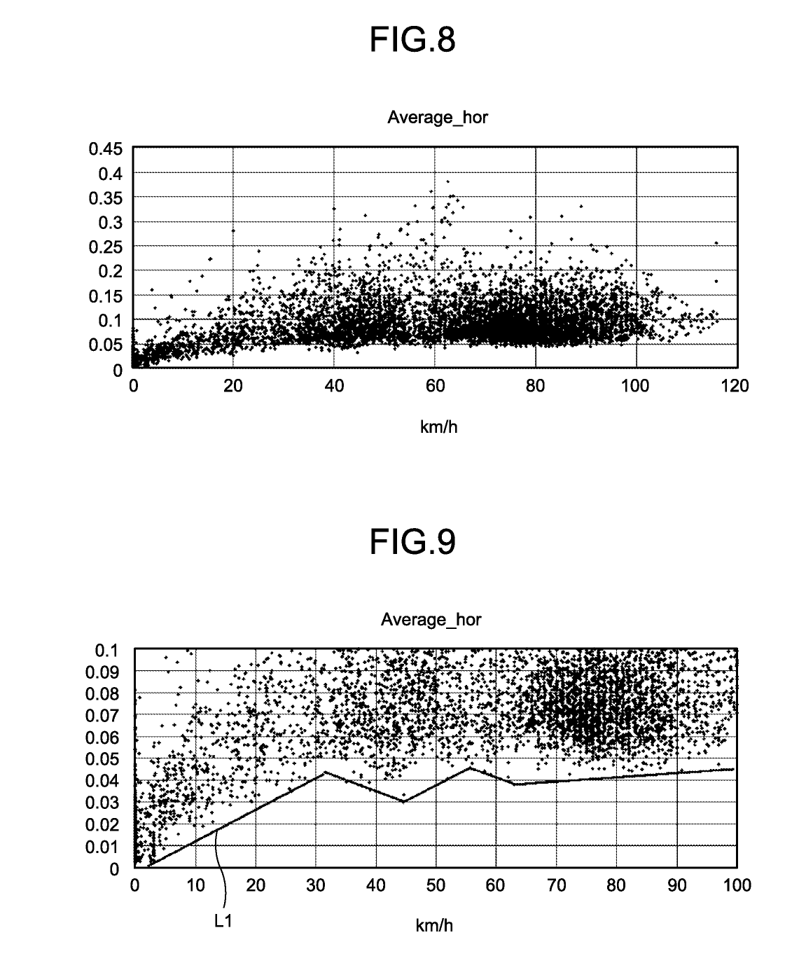

Before the limit value extraction process is described, the limit value will be described. FIG. 8 is a scatter diagram in which feature values (Average_hor) based on acceleration in the vertical direction with respect to the reference direction are plotted. More specifically, FIG. 8 is a scatter diagram obtained by plotting, as the feature values, the average value of “a_hor” that is the magnitude of the acceleration in the vertical direction with respect to the reference direction obtained for one second. The number of times the acceleration obtained for one second is about 50. The horizontal axis represents the speeds and the vertical axis represents the magnitude of the feature values. Furthermore, FIG. 9 is an enlarged view of the scatter diagram illustrated in FIG. 8.

As can be found from FIG. 9, the feature values are not substantially present below a line L1. In the case of the feature value (Average_hor) illustrated in FIG. 9, it is found that the lowest limit (the limit on the lower side) of the feature value in the vicinity of the line L1 is present. In particular, in the case of the example illustrated in FIG. 9, although linearity is not maintained in the vicinity of 40 km/h, it is found that the lower limit of the feature value indicates linearity in the vicinity at least of 30 km/h or more. Namely, it is found that there is a correlation between the limit value of the feature value (in a case of the example illustrated in FIG. 9, the lower limit) and the speed. If this characteristic is used, the terminal device 10 can estimate the speed from the feature value in at least the low speed range (for example, in the range between 0 km/h and 40 km/h).

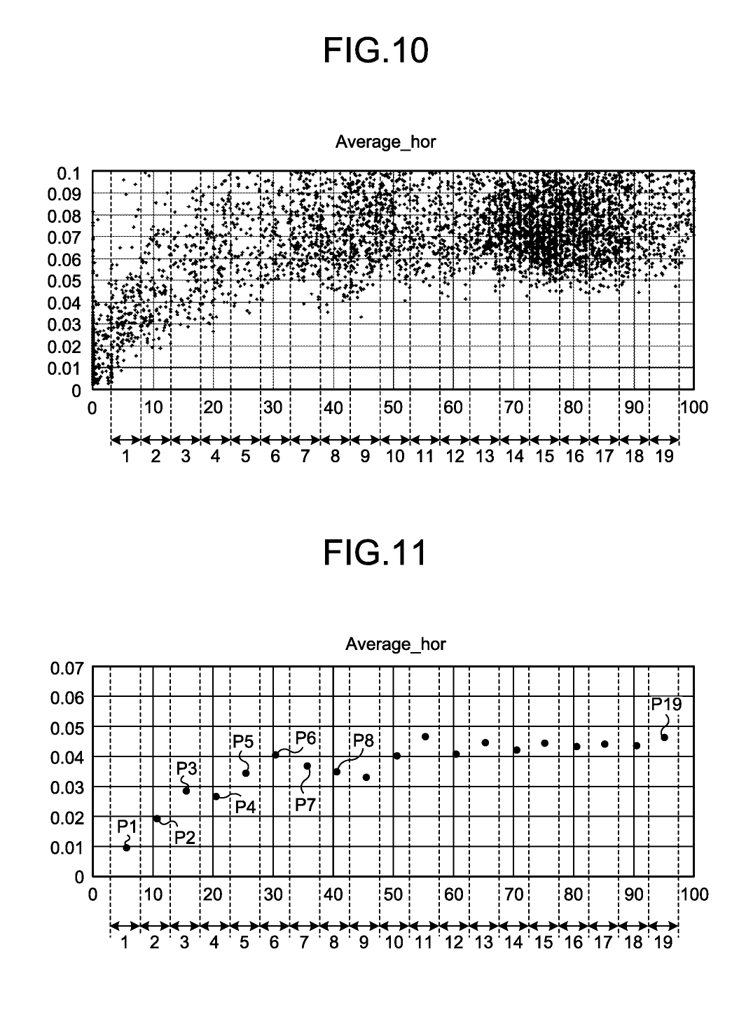

FIG. 10 is a diagram illustrating a state in which the scatter diagram of plotted feature values is divided by the speed ranges. The feature values plotted in FIG. 10 are the feature values (Average_hor) based on the acceleration in the vertical direction with respect to the reference direction. In the example illustrated in FIG. 10, the horizontal axis is divided into 19 speed ranges. A single range of the speed range is 5 km/h. The first speed range is 3 km/h to 8 km/h, the second speed range is 8 km/h to 13 km/h, the third speed range is 13 km/h to 18 km/h, the fourth speed range is 18 km/h to 23 km/h, the fifth speed range is 23 km/h to 28 km/h, the sixth speed range is 28 km/h to 33 km/h, the seventh speed range is 33 km/h to 38 km/h, and the eighth speed range is 38 km/h to 43 km/h. The last 19^{th} speed range is 93 km/h to 98 km/h.

Furthermore, FIG. 11 is a diagram illustrating a state in which limit values are plotted in each speed range. The symbol indicated by P1 is obtained by plotting the lower limits in the first speed range, P2 is obtained by plotting the lower limits in the second speed range, P3 is obtained by plotting the lower limits in the third speed range, P4 is obtained by plotting the lower limits in the fourth speed range, P5 is obtained by plotting the lower limits in the fifth speed range, P6 is obtained by plotting the lower limits in the sixth speed range, P7 is obtained by plotting the lower limits in the seventh speed range, and P8 is obtained by plotting the lower limits in the eighth speed range. The symbol indicated by P19 is obtained by plotting the lower limits in the 19^{th} speed range. In the example illustrated in FIG. 11, each of the symbols indicated by P1 to P19 is plotted at the middle of the corresponding speed range. The first to the 19^{th} speed ranges are associated with the first to the 19^{th} speed ranges, respectively, illustrated in FIG. 10.

As described above, the limit value of the feature value correlates with the speed. If the terminal device 10 can acquire the speed information on the GPS speed or the like, as illustrated in FIG. 11, the terminal device 10 obtains the limit value of the feature value in each speed range. Namely, the terminal device 10 previously obtains the relationship between the speed and the limit value when the speed information can be obtained. Because the feature value is calculated from the acceleration, even if the speed information is not able to be acquired because of, for example, entering a tunnel, it is possible to acquire the feature value. By previously obtaining the limit value in each speed range, the terminal device 10 can estimate the speed by using the feature value even if the terminal device 10 is not able to acquire the speed information about the inside of a tunnel.

### 2-5. Example of Operation and Advantages in Limit Value Extraction Process

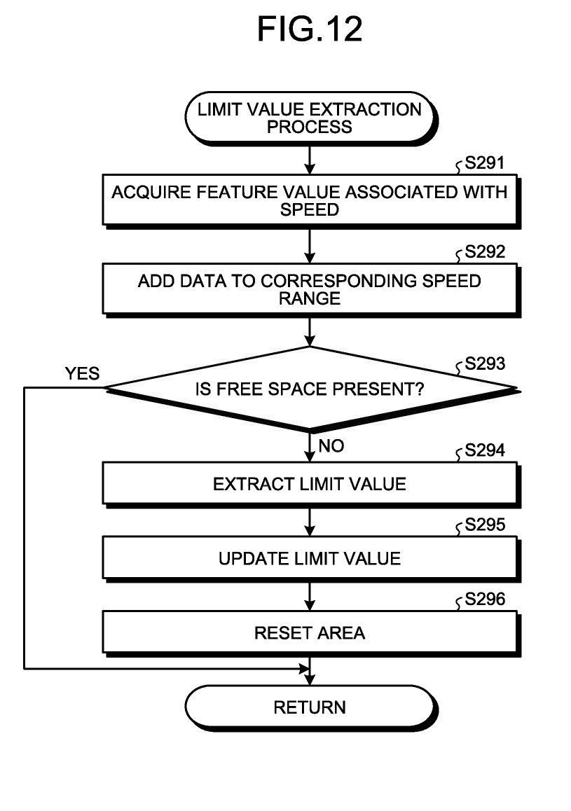

Thus, the judgement unit 25 performs the limit value extraction process of extracting the limit value of the feature value in each speed range. In the following, the content of the limit value extraction process that is performed and implemented by the judgement unit 25 will be described by using the flowchart illustrated in FIG. 12. FIG. 12 is a flowchart illustrating the flow of the limit value extraction process performed by the terminal device according to the embodiment. Furthermore, in a description below, a description will be given with the assumption that the limit value is the lower limit; however, the limit value may also be an upper limit. If the limit value is used as the upper limit, the “lower limit” in a description below is appropriately be read as the “upper limit”, the “minimum” is read as the “maximum”, “small” is read as “large”, “is small” is read as “is large”.

First, the judgement unit 25 acquires the feature value associated with the speed (Step S291). For example, the judgement unit 25 may also acquire the feature value associated with the speed from the feature value database 12b.

Then, the judgement unit 25 registers the acquired feature value in the speed range database 12c. At this time, the judgement unit 25 adds the data on the feature value to the corresponding speed range (Step S292). For example, it is assumed that the feature value database 12b is in the state illustrated in FIG. 4. If the feature value is 0.021 and the speed associated with the subject feature value is 30 km/h, the judgement unit 25 adds “0.021” to the data 10 that has the ID “6” and in which the speed range is 28 to 33 km/h. If the feature value is 0.113 and the speed associated with the subject feature value is 50 km/h, the judgement unit 25 adds “0.113” to the data 2 that has the ID “10” and in which the speed range is 48 to 53 km/h.

Then, the judgement unit 25 determines whether free space is present in the data area of the speed range to which the data of the feature value has been added (Step S293). For example, in the example illustrated in FIG. 4, because the number of storage areas of the feature values is 10, i.e., from the data 1 to the data 10, if all of the 10 storage areas are filled with the data of the feature values, the judgement unit 25 determines that no free space is present in the data area and, if the 10 storage areas are not filled with the data, the judgement unit 25 determines that free space is present in the data area. If the free space is present (Yes at Step S293), the judgement unit 25 ends the limit value extraction process.

If the free space is not present (No at Step S293), the judgement unit 25 extracts the limit value based on a predetermined number of pieces of data (in a case illustrated in FIG. 4, 10 pieces) stored in the data area in the corresponding speed range (Step S294). For example, if the feature value is the feature value (Average_hor) that is based on the acceleration in the vertical direction with respect to the reference direction, the judgement unit 25 may also acquire, as the limit value (lower limit), the minimum value from among the predetermined number of feature values. Furthermore, in order to exclude the effect of an abnormality value, the judgement unit 25 may also set, as the limit value (lower limit), the second smallest feature value from among the predetermined number of feature values, instead of setting the minimum value as the limit value (lower limit). At this time, the judgement unit 25 may also acquire the average of the speeds associated with the predetermined number of feature values as the representative speed of the calculated limit value.

Then, the judgement unit 25 updates the limit value acquired at Step S293 as the new limit value (Step S295). For example, the judgement unit 25 registers the limit value acquired at Step S294 in the field of the subject speed range in the limit value database 12d. If the representative speed can be stored in the limit value database 12d, the representative speed is also registered. Furthermore, if the already registered limit value is smaller than the limit value that was newly acquired at Step S294, the judgement unit 25 keeps the registration of the limit value database 12d without updating the limit value. In this case, the judgement unit 25 keeps the representative speed without updating the speed.

Then, regarding the subject speed ranges, the judgement unit 25 resets a predetermined number of data areas (Step S296). For example, in the example illustrated in FIG. 4, if “0.021” was added to the data 10 with the ID “6”, all of the 10 data areas indicated by the ID “6” are reset. Consequently, it is possible to newly store the feature values in the subject speed range. After the completion of the reset of the data areas, the control unit 16 ends the limit value extraction process and the limit value update process.

### 2-6. Example of Operation and Advantages in Estimation Process

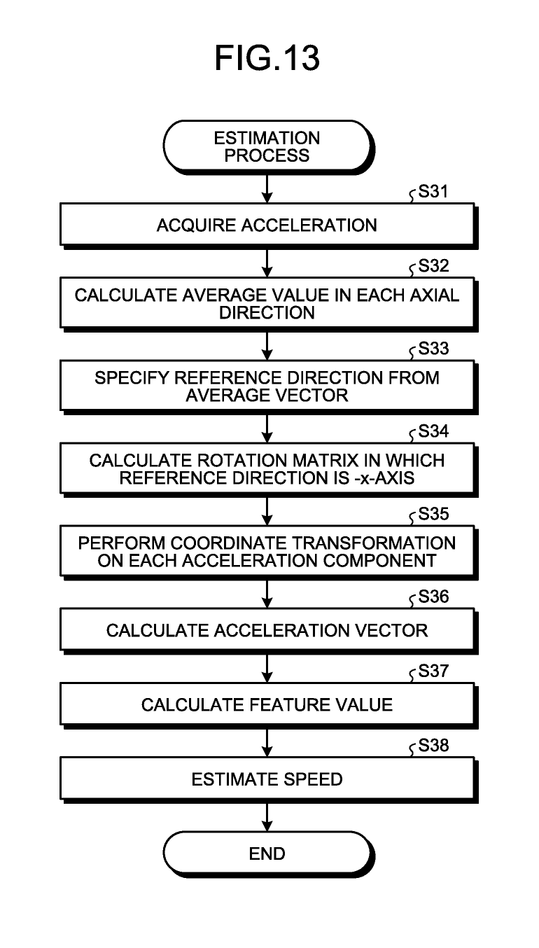

In the following, the content of the estimation process performed and implemented by the estimation unit 26 will be described by using the flowchart illustrated in FIG. 13. FIG. 13 is a flowchart illustrating the flow of the estimation process performed by the terminal device 10 according to the embodiment. The estimation process is performed when, for example, the position information based on the positioning signal is not able to be acquired. For example, if it is determined that the GPS is not able to be used at Step S13 illustrated in FIG. 6, the estimation unit 26 performs the estimation process illustrated in FIG. 13. The process illustrated in FIG. 13 is associated with, for example, the process indicated at Step S5 illustrated in FIG. 1.

Furthermore, the terminal device 10 may also perform the speed estimation process that estimates the moving speed of the moving object or the terminal device 10, other than the estimation process illustrated in FIG. 13. The speed estimation process may also be a process performed by using the learning model based on the SVM (for example, the speed estimation model described above) or may also simply be a process that uses the speed (for example, a speed at the time of entering a tunnel) at the position in which the GPS is not able to be used as an estimated speed without changing anything. In this case, the result of the estimation process illustrated in FIG. 13 may also be as a limit limiter (also called the “maximum speed” or a “limit speed”) of the speed estimated in the speed estimation process (hereinafter, referred to as an estimated speed). Namely, if the estimated speed is greater than the maximum speed estimated by the estimation process illustrated in FIG. 13, the terminal device 10 replaces the estimated speed with the maximum speed.

In the following, the estimation process will be described with reference to FIG. 13. In a description below, it is assumed that the estimation unit 26 estimates the maximum speed; however, the speed estimated by the estimation unit 26 is not limited to the maximum speed. The speed estimated by the estimation unit 26 may also be the moving speed of the moving object or the terminal device 10. In this case, the “maximum speed” described below is appropriately replaced by a “moving speed”.

First, the estimation unit 26 acquires the acceleration from the acceleration sensor 13 (Step S31). Then, the estimation unit 26 calculates, for each axial direction of the terminal coordinate system, the average value of the magnitude of the acceleration measured by the acceleration sensor 13 in a predetermined period of time (Step S32). Then, the estimation unit 26 specifies the reference direction based on the acceleration acquired at Step S31. For example, the estimation unit 26 specifies the reference direction from the average vector of the acceleration (Step S33). Then, the estimation unit 26 calculates the rotation matrix that is used to match a predetermined axial direction of the terminal coordinate system with the reference direction (Step S34). Then, the estimation unit 26 transforms, by using the calculated rotation matrix, each of the components of the acceleration acquired from the terminal coordinate system (Step S35). Thereafter, the estimation unit 26 calculates the acceleration vector (Step S36). For example, the estimation unit 26 calculates the magnitude of the acceleration vector based on the acceleration acquired at Step S31. Then, the estimation unit 26 calculates the feature value based on the magnitude of the acceleration vector calculated at Step S36 (Step S37). The processes performed at Steps S31 to S37 are the same as those performed at Steps S21 to S27 in the limit value update process.

Subsequently, the estimation unit 26 estimates the speed based on the feature value calculated at Step S37 and based on the limit value in each speed range acquired in the limit value update process (Step S38). For example, the estimation unit 26 estimates, as the maximum speed, the speed that is determined based on the information on the limit value in each speed range and that uses the value of the feature value calculated at Step S37 as the limit value. As described above, the limit value in each speed range is stored in the limit value database 12d illustrated in FIG. 5. In the following, an example of the process performed at Step S38 will be described with reference to FIG. 5.

First, the estimation unit 26 stores, in a variable id_R, the ID associated with the greatest speed range from among the speed ranges in each of which the limit value is registered. Then, the estimation unit 26 stores, in a variable id_L, the ID associated with the second greatest speed range from among the speed ranges in each of which the limit value is registered. If id_L is not found, the estimation unit 26 ends the estimation process because the estimation unit 26 is not able to estimate the speed. If id_L is found, the estimation unit 26 plots the limit value in the speed range indicated by the variable id_R and the limit value in the speed range indicated by the variable id_L on a graph. The graph is the graph, such as that illustrated in, for example, FIG. 11, in which the vertical axis represents the magnitude of the feature value and the horizontal axis represents the speed. The position of each of the limit values on the horizontal axis may also be the middle of the speed range that is associated with the corresponding limit value or may also be the position of the representative speed associated with the corresponding limit value.

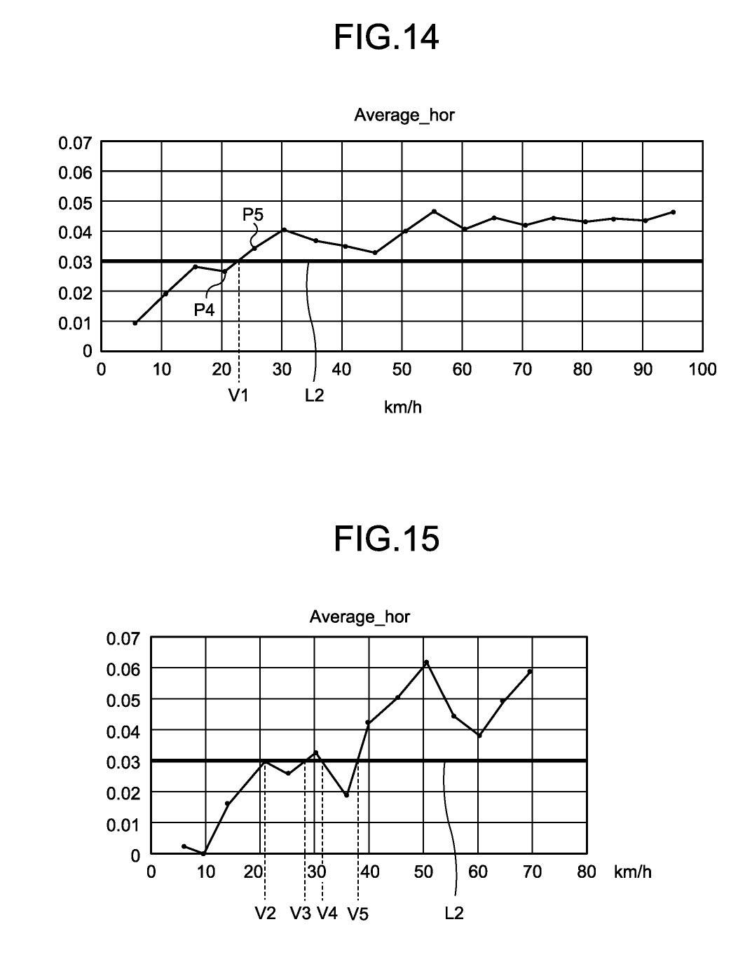

Then, the estimation unit 26 connects the two plotted points. FIG. 14 is a diagram illustrating a state in which plotted limit values are connected by a line in the graph. More specifically, FIG. 14 illustrates the graph obtained by connecting the points P1 to P19 illustrated in FIG. 11. The estimation unit 26 determines whether the line connecting the plotted two points intersects the horizontal straight line that indicates the value of the feature value acquired at Step S37 as the value on the vertical axis. For example, it is assumed that the plotted two points are P5 and P4 illustrated in FIG. 14 and the feature value acquired at Step S37 is 0.03. In the example illustrated in FIG. 14, because the line connecting P5 and P4 intersects a line L2 of the horizontal straight line that indicates 0.03 as the values on the vertical axis, the estimation unit 26 determines that the two lines intersect each other. If the two lines intersect, the estimation unit 26 estimates that the speed indicated by the intersection point (V1 in the example illustrated in FIG. 14) as the maximum speed and then ends the estimation process.

If the two lines do not intersect, the estimation unit 26 substitutes the variable id L for the variable id_R. Then, the estimation unit 26 stores, in the variable id_L, the ID associated with the second greatest speed range subsequent to variable id_R from among the speed ranges in each of which the limit value is registered. Then, the estimation unit 26 again plots the limit value in the speed range indicated by the variable id_R and the limit value in the speed range indicated by the variable id_L on the graph. Then, the estimation unit 26 determines whether the line connecting the two plotted points intersects the line of the horizontal straight line that indicates the value of the feature value acquired at Step S37 as the value on the vertical axis. The estimation unit 26 repeats the process described above until an intersection point is found. If the intersection point is found, the estimation unit 26 estimates the speed indicated by the intersection point as the maximum speed and ends the estimation process. If no intersection point is found, the estimation unit 26 ends the estimation process because the estimation unit 26 is not able to estimate the speed.

Furthermore, there may be a case in which a plurality of speeds that uses the value of the feature value calculated at Step S37 as the limit value. FIG. 15 is a graph illustrating an example different from that illustrated in FIG. 14. In the example illustrated in FIG. 15, similarly to FIG. 14, the limit values plotted on the graph are connected by a line. In the example illustrated in FIG. 15, the line L2 of the horizontal straight line that indicates 0.03 as the values on the vertical axis intersects the line connecting the limit values at a plurality of points. Namely, in the example illustrated in FIG. 15, if the value of the feature value calculated at Step S37 is 0.03, the speed that takes the limit value of 0.03 is present at four points indicated by V2, V3, V4, and V5. In this case, considering that the maximum speed functions as a speed limiter, the estimation unit 26 may also select the highest speed from among the plurality of speeds as the maximum speed. In a case of the example illustrated in FIG. 15, the estimation unit 26 may also estimate, as the maximum speed, the highest speed indicated by V5 from among the four speeds indicated by V2, V3, V4, and V5. Furthermore, the estimation unit 26 may also estimate the lowest speed from among the plurality of speeds as the maximum speed or may also estimate the median value of the plurality of speeds as the maximum speed. Furthermore, the estimation unit 26 may also use the average value of the plurality of speeds as the maximum speed.

### 3. Example of Mathematical Expressions

In the following, a description will be given of an example of a process in which the transformation unit 23 calculates the rotation matrix that is used to transform the terminal coordinate system to the estimation coordinate system by using mathematical expressions. Furthermore, the processes performed by the transformation unit 23 are not limited to the processes indicated by the mathematical expressions described below. For example, the transformation unit 23 may also perform coordinate transformation from the terminal coordinate system to the estimation coordinate system by using the mathematical expression that represents a linear transformation.

For example, each of the axes of the terminal coordinate system is set to x-, y-, or z-axis and each of the axes of the estimation coordinate system is set to X-, Y-, or Z-axis. In such a case, the process of transforming the estimation coordinate system to the terminal coordinate system is represented by Expression (1) below. Furthermore, in Expression (1), the rotation angle about the x-axis is represented by α, the rotation angle about the y-axis is represented by β, the rotation angle about the z-axis is represented by γ, the rotation matrix used to perform the coordinate transformation based on the rotation about the x-axis is represented by Rₓ(α), the rotation matrix used to perform the coordinate transformation based on the rotation about the y-axis is represented by R_{y}(β), and the rotation matrix used to perform the coordinate transformation based on the rotation about the z-axis is represented by R_{z}(γ).

$$( \begin{matrix}x \\ y \\ z\end{matrix} ) = {R}_{z} ( γ ) {R}_{y} ( β ) {R}_{x} ( α ) ( \begin{matrix}X \\ Y \\ Z\end{matrix} ) \qquad ( 1 )$$

Furthermore, the rotation matrix Rₓ(α), the rotation matrix R_{y}(β), and the rotation matrix R_{z}(γ) (hereinafter, sometimes correctively referred to as “each rotation matrix”) can be represented by Expressions (2) to (4) below. Furthermore, because, in the estimation coordinate system, the −x-axis direction needs to be matched with the direction of the average vector G, an arbitrary value can be set to the value of α.

$$\begin{matrix}{R}_{x} ( α ) = ( \begin{matrix}1 & 0 & 0 \\ 0 & cos α & - sin α \\ 0 & sin α & cos α\end{matrix} ) & ( 2 ) \\ {R}_{y} ( β ) = ( \begin{matrix}cos β & 0 & sin β \\ 0 & 1 & 0 \\ - sin β & 0 & cos β\end{matrix} ) & ( 3 ) \\ {R}_{z} ( γ ) = ( \begin{matrix}cos γ & - sin γ & 0 \\ sin γ & cos γ & 0 \\ 0 & 0 & 1\end{matrix} ) & ( 4 )\end{matrix}$$

Here, the direction of the average vector G is the acceleration in the −X-axis direction and thus can be represented by, in the estimation coordinate system, Expression (5) below.

$$( \begin{matrix}X \\ Y \\ Z\end{matrix} ) = ( \begin{matrix}- G \\ 0 \\ 0\end{matrix} ) \qquad ( 5 )$$

In contrast, the average vector G in each of the axial directions detected in the terminal coordinate system is represented by (aₓ, a_{y}, a_{z}). In this case, because aₓ, a_{y}, and a_{z} are the values obtained by transforming the average vector G represented by Expression (5) by each rotation matrix, Expression (6) below holds.

$$( \begin{matrix}{a}_{x} \\ {a}_{y} \\ {a}_{z}\end{matrix} ) = {R}_{z} ( γ ) {R}_{y} ( β ) {R}_{x} ( α ) ( \begin{matrix}- G \\ 0 \\ 0\end{matrix} ) = ( \begin{matrix}- G cos β cos γ \\ - G cos β sin γ \\ G sin β\end{matrix} ) \qquad ( 6 )$$

Consequently, Expression (7) is obtained from the value of the z-axis direction in Expression (6).

$$sin β = \frac{{a}_{z}}{G} \qquad ( 7 )$$

Furthermore, when considering the magnitude of the average vector G, Expression (8) holds; therefore, Expression (9) is obtained from the values of the x-axis and y-axis directions represented by Expression (6). Consequently, the terminal device 10 can specify the rotation angle β about the y-axis from Expressions (7) and (9).

$$\begin{matrix}{G}^{2} = {a}_{x}^{2} + {a}_{y}^{2} + {a}_{z}^{2} & ( 8 ) \\ cos β = \sqrt[\pm ]{1 - {( \frac{{a}_{z}}{G} )}^{2}} = \pm \frac{\sqrt{{a}_{x}^{2} + {a}_{y}^{2}}}{G} & ( 9 )\end{matrix}$$

Here, from among the value represented by Expression (9), the positive value is selected as a solution. Then, Expressions (10) and (11) are obtained from the values of the x-axis and y-axis directions in Expression (6). Consequently, the terminal device 10 can specify the rotation angle γ about the z-axis from Expressions (10) and (11).

$$\begin{matrix}sin γ = - \frac{{a}_{y}}{\sqrt{{a}_{x}^{2} + {a}_{y}^{2}}} & ( 10 ) \\ cos γ = - \frac{{a}_{x}}{\sqrt{{a}_{x}^{2} + {a}_{y}^{2}}} & ( 11 )\end{matrix}$$

In contrast, the process of transforming the terminal coordinate system to the estimation coordinate system is inverse transformation of the coordinate transformation indicated by Expression (1); therefore, the process can be represented by Expression (12) below.

$$( \begin{matrix}X \\ Y \\ Z\end{matrix} ) = {R}_{x} ( - α ) {R}_{y} ( - β ) {R}_{z} ( - γ ) ( \begin{matrix}x \\ y \\ z\end{matrix} ) \qquad ( 12 )$$

Furthermore, because the values of β and γ can be calculated from Expressions (7), (9), (10), and (11), when only the y-axis and the z-axis from among the samples aₓ, a_{y}, and a_{z} of the acceleration of the terminal coordinate system are rotated and transformed to the estimation coordinate system, Expression (13) holds. Namely, the terminal device 10 transforms the terminal coordinate system to the estimation coordinate system by using the rotation matrix R_{y}(β) and the rotation matrix R_{z}(γ).

$$( \begin{matrix}X \\ y \\ z\end{matrix} ) = {R}_{y} ( - β ) {R}_{z} ( - γ ) ( \begin{matrix}{a}_{x} \\ {a}_{y} \\ {a}_{z}\end{matrix} ) \qquad ( 13 )$$

### 4. Modification

The terminal device 10 according to the embodiment described above may also be performed with various kinds of embodiments other than the embodiment described above. Therefore, another embodiment of the terminal device 10 described above will be described below.

### 4-1. Feature Value

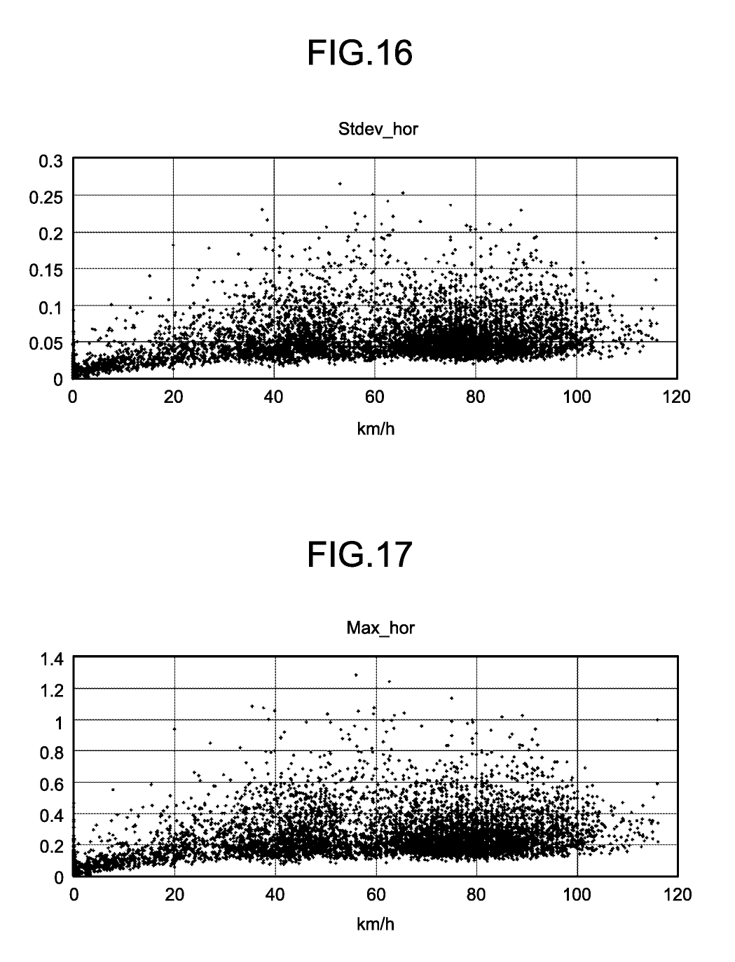

In the embodiment described above, the average value (Average_hor) of the magnitude of the acceleration in the vertical direction with respect to the reference direction obtained in a predetermined period or a predetermined number of times is acquired as the feature value. However, the feature value does not always need to be Average_hor. For example, the terminal device 10 may also use, as the feature value, the standard deviation (hereinafter, also referred to as Stdev_hor) of the magnitude of the acceleration in the vertical direction with respect to the reference direction obtained in a predetermined period or a predetermined number of times. FIG. 16 is a scatter diagram in which feature values (Stdev_hor) based on the acceleration in the vertical direction with respect to the reference direction are plotted. More specifically, FIG. 16 is a scatter diagram obtained by plotting, as the feature values, the standard deviation of the magnitude “a_hor” of the acceleration in the vertical direction with respect to the reference direction for one second. The number of times the acceleration is acquired for one second is about 50 times. The horizontal axis represents the speeds and the vertical axis represents the magnitude of the feature values. As can be seen from FIG. 16, the feature value is not substantially present below a certain line. Namely, similarly to Average_hor, it is found that, regarding the feature value (Stdev_hor), the limit value (lower limit) of the feature value is also present. Even if Stdev hor is used as the feature value, the terminal device 10 can estimate the speed in the same way used in the process (the limit value update process, the limit value extraction process, and the estimation process) based on Average_hor described above.

Furthermore, the terminal device 10 may also use, as the feature value, the maximum value (hereinafter, also referred to as Max_hor) of the acceleration in the vertical direction with respect to the reference direction obtained in a predetermined period or a predetermined number of times. FIG. 17 is a scatter diagram in which feature values (Max_hor) based on the acceleration in the vertical direction with respect to the reference direction are plotted. More specifically, FIG. 17 is a scatter diagram obtained by plotting, as the feature values, the maximum values of the magnitude “a_hor” of the acceleration in the vertical direction with respect to the reference direction for one second. The number of times the acceleration is acquired for one second is about 50 times. The horizontal axis represents the speeds and the vertical axis represents the magnitude of the feature values. As can be seen from FIG. 17, the feature value is not substantially present below a certain line. Namely, similarly to Average_hor, it is found that, regarding the feature value (Max_hor), the limit value (lower limit) of the feature value is also present. Even if Max_hor is used as the feature value, the terminal device 10 can estimate the speed in the same way used in the process (the limit value update process, the limit value extraction process, and the estimation process) based on Average_hor described above.

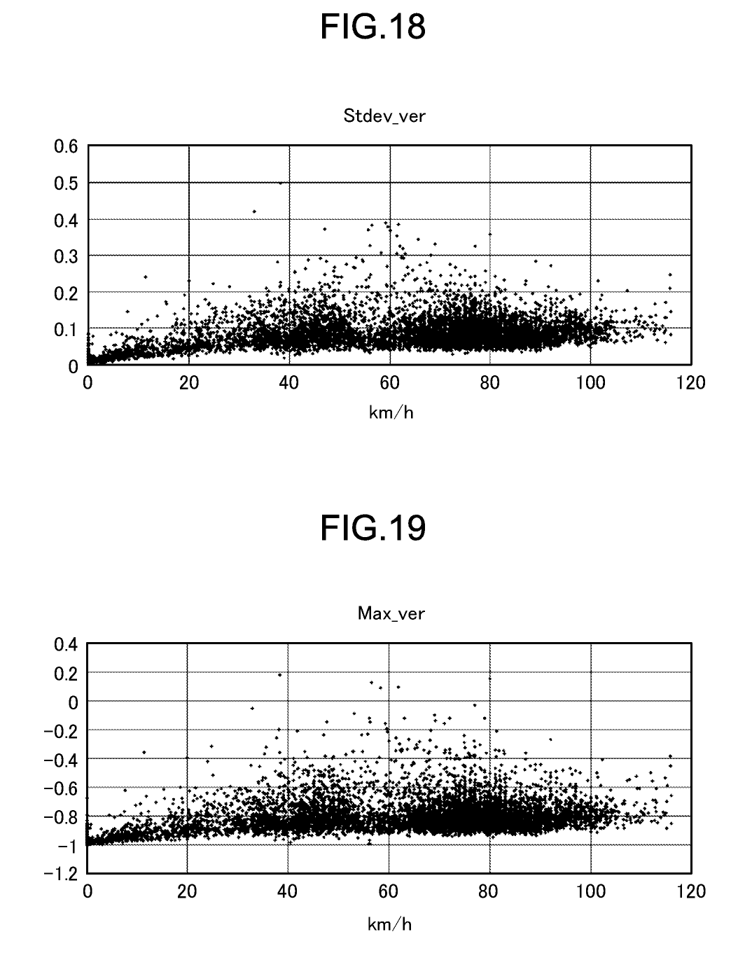

Furthermore, the terminal device 10 may also use, as the feature value, the value based on the magnitude of the acceleration in the reference direction. For example, the terminal device 10 may also calculate, as the feature value, the standard deviation (hereinafter, also referred to as Stdev_ver) of the magnitude of the acceleration in the reference direction obtained in a predetermined period in a predetermined number of times. FIG. 18 is a scatter diagram in which feature values (Stdev_ver) based on the acceleration in the reference direction are plotted. More specifically, FIG. 18 is a scatter diagram obtained by plotting, as the feature values, the standard deviation of the magnitude “a_ver” of the acceleration in the reference direction for one second. The number of times the acceleration is acquired for one second is about 50 times. The horizontal axis represents the speeds and the vertical axis represents the magnitude of the feature values. As can be seen from FIG. 18, the feature value is not substantially present below a certain line. Namely, similarly to Average_hor, it is found that, regarding the feature value (Stdev_ver), the limit value (lower limit) of the feature value is also present. Even if Stdev ver is used as the feature value, the terminal device 10 can estimate the speed in the same way used in the process (the limit value update process, the limit value extraction process, and the estimation process) based on Average_hor described above.

Furthermore, the terminal device 10 may also use, as the feature values, the maximum values (hereinafter, also referred to as Max_ver) of the magnitude of the acceleration in the reference direction obtained in a predetermined period or a predetermined number of times. FIG. 19 is a scatter diagram in which feature values (Max_ver) based on the acceleration in the reference direction are plotted. More specifically, FIG. 19 is a scatter diagram obtained by plotting, as the feature values, the maximum values of the magnitude “a_ver” of the acceleration in the reference direction for one second. The number of times the acceleration is acquired for one second is about 50 times. The horizontal axis represents the speeds and the vertical axis represents the magnitude of the feature values. As can be seen from FIG. 19, the feature value is not substantially present below a certain line. Namely, similarly to Average_hor, it is found that, regarding the feature value (Max_ver), the limit value (lower limit) of the feature value is also present. Even if Max_ver is used as the feature value, the terminal device 10 can estimate the speed in the same way used in the process (the limit value update process, the limit value extraction process, and the estimation process) based on Average_hor described above.

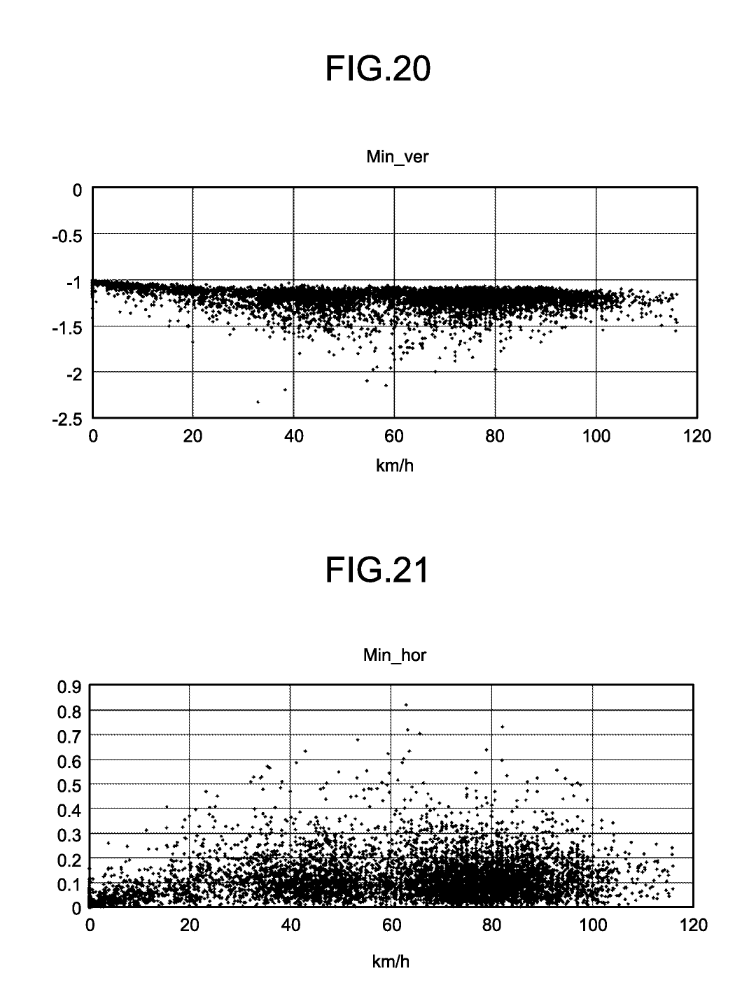

Furthermore, the terminal device 10 may also calculate, as the feature values, the minimum value (hereinafter, also referred to as Min_ver) of the magnitude of the acceleration in the reference direction obtained in a predetermined period or a predetermined number of times. FIG. 20 is a scatter diagram in which feature values (Min_ver) based on the acceleration in the reference direction are plotted. More specifically, FIG. 20 is a scatter diagram obtained by plotting, as the feature values, the minimum values of the magnitude “a_ver” of the acceleration in the reference direction for one second. The number of times the acceleration is acquired for one second is about 50 times. The horizontal axis represents the speeds and the vertical axis represents the magnitude of the feature values. As can be seen from FIG. 20, the feature value is not substantially present below a certain line. In a case of the feature value (Min_ver), it is found that the limit value (upper limit) is present in the feature value. Even if Min_ver is used as the feature value, the terminal device 10 can estimate the speed in the same way used in the process (the limit value update process, the limit value extraction process, and the estimation process) based on Average_hor described above. Furthermore, if the feature value is set to Min_ver, the limit value corresponds to the upper limit, instead of the lower limit. Thus, the “lower limit” described above in the process needs to appropriately be read as the “upper limit”, the “minimum” needs to be read as the “maximum”, “small” is read as “large”, “is small” is read as “is large”.

Furthermore, for comparison, an example of using, as the feature values, the minimum values (hereinafter, also referred to as Min_hor) of the magnitude of the acceleration in the vertical direction with respect to the reference direction obtained in a predetermined period or a predetermined number of times is also indicated. FIG. 21 is a scatter diagram in which feature values (Min_hor) based on the acceleration in the vertical direction with respect to the reference direction are plotted. More specifically, FIG. 21 is a scatter diagram obtained by plotting, as the feature values, the minimum values of the magnitude “a_hor” of the acceleration in the vertical direction with respect to the reference direction. The number of times the acceleration is acquired for one second is about 50 times. The horizontal axis represents the speeds and the vertical axis represents the magnitude of the feature values. In a case of example illustrated in FIG. 21, linear limit values are not found in the feature values.

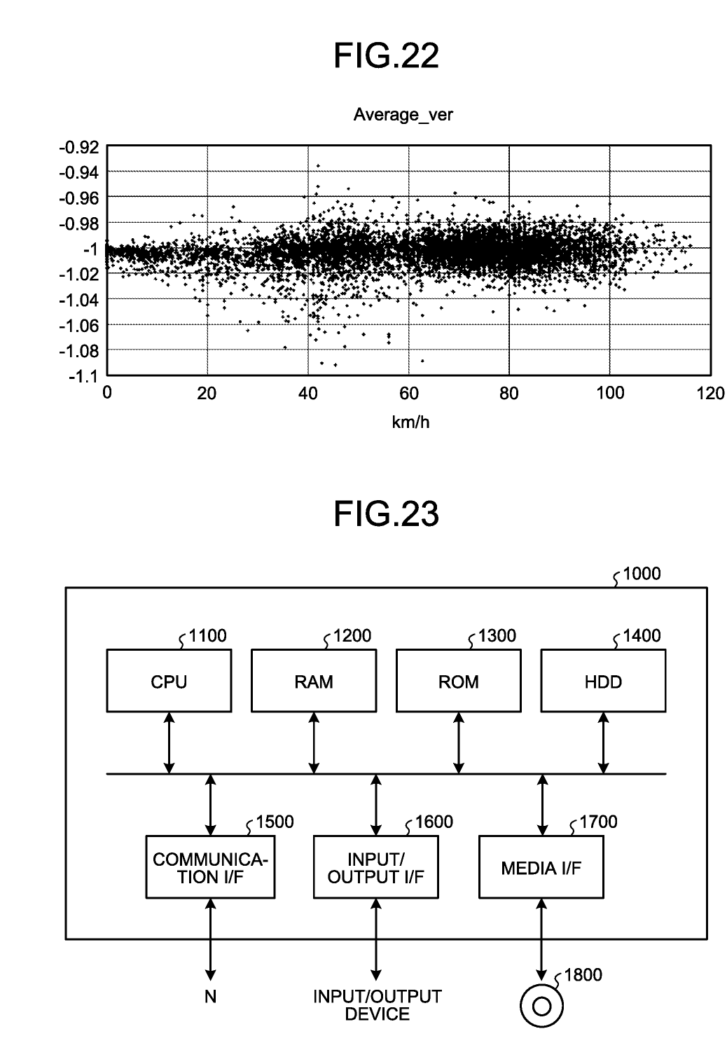

Furthermore, for comparison, an example of using, as the feature values, the average values (hereinafter, also referred to as Average_ver) of the magnitude of the acceleration in the reference direction obtained in a predetermined period or a predetermined number of times is also indicated. FIG. 22 is a scatter diagram in which feature values (Average_ver) based on the acceleration in the reference direction are plotted. More specifically, FIG. 22 is a scatter diagram obtained by plotting, as the feature values, average values of the magnitude “a_ver” of the acceleration in the reference direction for one second. The number of times the acceleration is acquired for one second is about 50 times. The horizontal axis represents the speeds and the vertical axis represents the magnitude of the feature values. In also a case of example illustrated in FIG. 22, linear limit values are not found in the feature values.

### 4-2. Speed Range Using Estimation Results

In the embodiment described above, the speed range estimated by the estimation unit 26 is not limited; however, the speed range estimated by the estimation unit 26 may also be a part of range. As already described with reference to FIG. 9, the limit value (lower limit) of the feature value (Average_hor) indicates linearity in a low speed area (for example, the range between 0 km/h and 40 km/h). As can be seen from FIGS. 16 to 20, this characteristic is also exhibited in other feature values (Stdev_hor, Max_hor, Stdev_ver, Max_ver, and Min_ver). Thus, the estimation unit 26 may also limits the speed range estimated by the estimation unit 26 to a speed equal to or less than a predetermined threshold speed.

For example, it is assumed that the terminal device 10 has performed the speed estimation process separately from the estimation process illustrated in FIG. 13. If the maximum speed estimated in the estimation process is lower than a predetermined threshold speed, the estimation unit 26 limits the estimated speed estimated in the speed estimation process to the maximum speed, whereas, if the maximum speed is higher than a predetermined threshold speed, the estimation unit 26 does not limit the estimated speed to the maximum speed.

In the embodiment described above, if a plurality of speeds in which the value of a predetermined feature value is a limit value is present, the estimation unit 26 estimates, from among the plurality of speeds, the highest speed as the speed of the predetermined feature value. However, from among the plurality of speeds, the estimation unit 26 may also estimate the highest speed out of the speed lower than the predetermined threshold speed as the speed of the predetermined feature value. Furthermore, the estimation unit 26 may also estimate the lowest speed from among the speed lower than the predetermined threshold speed as the maximum speed or may also use the median value of a plurality of speeds lower than the predetermined threshold speed as the maximum speed. Furthermore, the estimation unit 26 may also use the average value of the plurality of speeds lower than the predetermined threshold speed as the maximum speed.

Furthermore, a predetermined threshold speed may also be the speed selected from the speeds equal to or less than 40 km/h. In order to more accurately perform estimation, the predetermined threshold speed may also be the speed selected from the speeds equal to or less than 30 km/h. Of course, the predetermined threshold speed may also be the speed selected from the speeds equal to or less than 20 km/h or the speed selected from the speeds equal to or less than 10 km/h.

### 4-3. Interval of Processing

Furthermore, in the embodiment described above, the terminal device 10 performs the limit value update process and the estimation process at intervals of one second. However, the execution interval of the process is not limited to this. The limit value update process and the estimation process may also be performed at arbitrary timing.

### 4-4. Orientation Change

Furthermore, the terminal device 10 may also specify the orientation of the terminal device 10. For example, if the acceleration in a certain period of time is averaged, the direction of the subject average vector G matches the direction of the gravitational acceleration. Thus, the terminal device 10 compares, for example, the directions of the average vectors of all of the acceleration measured after an application was started up in the direction of the average vector of the acceleration detected for the latest one second and, if directions differ by an angle of 37° or more (i.e., if a cosine value of the angle between each of the average vectors is smaller than 0.8), it may also be determined that the orientation of the terminal device 10 has been changed.

When it is determined that the orientation has been changed, the terminal device 10 may also delete the data registered in the speed range database 12c or the limit value database 12d or the data registered in the model 12e, collect new data, and perform learning of the limit values and the model. Consequently, the terminal device 10 can reduce the degradation of the estimation accuracy when the orientation is changed.

### 4-5. Other Embodiments

The embodiments described above are only examples and the present invention also includes examples described below and other embodiments. For example, the functional configuration, data structure, and the order and the content of the processes indicated by the flowcharts described in the present application are only examples. The presence or absence of each element, the placement thereof, the order of the processes to be performed, specific content, and the like may be appropriately changed. For example, the navigation process and the estimation process described above can also be implemented by, other than the terminal device 10 described above in the embodiment, a device in a terminal that is implemented by an application in a smartphone, and implemented by a method or a program.

The components of each device illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

For example, each of the processing units (the navigation execution unit 17 to the moving state estimation unit 20) constituting the terminal device 10 may also be implemented by an independent device. Furthermore, each of the units (the detecting unit 21 to the prediction unit 28) constituting the moving state estimation unit 20 may also be implemented by an independent device. Similarly, the configuration of the present embodiments can be flexibly changed, such as each of the means described above in the embodiment being implemented by calling an external platform or the like by using an application program interface (API) or network computing (so-called cloud, etc.). Furthermore, each of the elements, such as the means, related to the present embodiments is not limited to a computing control unit in a computer and may also be implemented by another information processing mechanism, such as a physical electronic circuit.

For example, the terminal device 10 may also perform the navigation process described above by the terminal device 10 cooperating with a distribution server that can communicate with each other. For example, the distribution server includes the detecting unit 21, the setting unit 22, the transformation unit 23, the acquiring unit 24, the judgement unit 25, and the creating unit 27 and may also collect feature values from the acceleration detected by the terminal device 10; perform learning of the model by using the collected feature values; and distribute the learned model to the terminal device 10. Furthermore, such a distribution server may also perform learning of each of the models for each terminal device that has collected the learning data or may also learn, at the time of collecting learning data, each of the models for each state, such as the type of vehicle in which the terminal device 10 is disposed, the type of tire, and the conditions of a road and weather. When having performed the learning described above, the distribution server may also distribute, to the terminal device 10 from among the learned models, the model that is in accordance with the circumstances in a case where the terminal device 10 performs the estimation process.

Furthermore, the distribution server includes the detecting unit 21, the setting unit 22, the transformation unit 23, the acquiring unit 24, and the estimation unit 26 and may also distribute the estimated moving speed to the terminal device 10 based on the value of the acceleration detected by the terminal device 10 and navigate a user. Furthermore, instead of the terminal device 10, the distribution server may also allow the terminal device 10 to perform the navigation process by performing the estimation process and sending the executing results to the terminal device 10.

Furthermore, if there are a plurality of terminal devices that perform the navigation process and the estimation process in corporation with the distribution server, the distribution server may also determine, by using an SVM that is different for each terminal device, whether each of the terminal devices is moving. Furthermore, the distribution server may also implement the learning of SVMs by collecting the position information acquired by each of the terminal devices by the GPS; determining, based on the collected position information, whether each of the terminal devices is moving; and using the determination result and the value of the acceleration collected from each of the terminal devices.

Furthermore, of the processes described in the embodiment, the whole or a part of the processes that are mentioned as being automatically performed can also be manually performed, or the whole or a part of the processes that are mentioned as being manually performed can also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

Each of the embodiments may be appropriately used in combination as long as the processes do not conflict with each other.

In addition, the control device that controls the terminal device 10 according to the embodiment may also implemented by a dedicated computer system or implemented by a general computer system. For example, the control device may also be configured by storing a program or data (for example, the model 12e) that is used to execute the operation described above in a computer readable recording medium, such as an optical disk, a semiconductor memory, a magnetic tape, a flexible disk; distributing the program or the data; installing the program or the data in the computer; and executing the processes described above. The control device may also be an external device (for example, a personal computer) provided outside the terminal device 10 or may also be an internal device (for example, the control unit 16). Furthermore, the program or the data described above may also be stored in a disk device provided in a server device in a network, such as the Internet, and configured such that the program or the data can be, for example, downloaded to the computer. Furthermore, the function described above may also be implemented by the OS (Operating System) and application software in cooperation with each other. In this case, the portion other than the OS may also be stored in a medium and distributed or, alternatively, the portion other than the OS may also be stored in the server device and be configured such that the portion other than the OS can be, for example, downloaded to the computer.

### 5. Hardware Configuration

The terminal device 10 according to the embodiment and the modification can also be implemented by a computer 1000 having the configuration illustrated in, for example, FIG. 23. FIG. 23 is a hardware configuration diagram illustrating an example of a computer that implements the function of the terminal device 10. The computer 1000 includes a central processing unit (CPU) 1100, a RAM 1200, a ROM 1300, a hard disk drive (HDD) 1400, a communication interface (I/F) 1500, an input/output interface (I/F) 1600, and a media interface (I/F) 1700.

The CPU 1100 is operated based on the program stored in the ROM 1300 or the HDD 1400. The ROM 1300 stores therein a boot program that is executed by the CPU 1100 when the computer 1000 is started up, a program dependent on the hardware of the computer 1000, and the like.

The HDD 1400 stores therein the program executed by the CPU 1100, data used by the program, and the like. The communication interface 1500 receives data from another apparatus via a network N, sends the data to the CPU 1100, and sends the data generated by the CPU 1100 to another device via the network N.

The CPU 1100 controls, via the input/output interface 1600, an output device, such as a display or a printer, and an input device, such as a keyboard or a mouse. The CPU 1100 acquires data from the input device via the input/output interface 1600. Furthermore, the CPU 1100 outputs the generated data to the output device via the input/output interface 1600.

The media interface 1700 reads the program or the data stored in the recording medium 1800 and provides the program or the data to the CPU 1100 via the RAM 1200. The CPU 1100 loads the program into the RAM 1200 from the recording medium 1800 via the media interface 1700 and executes the loaded program. The recording medium 1800 is, for example, an optical recording medium, such as Digital Versatile Disc (DVD) or a Phase change rewritable Disk (PD), a magneto optical recording medium, such as a magneto-optical disk (MO), a tape medium, a magnetic recording medium, a semiconductor memory, or the like.

For example, when the computer 1000 functions as the terminal device 10 according to the embodiment, the CPU 1100 in the computer 1000 implements the functions of the control unit 16 by executing the program or the data (for example, the model 12e) loaded into the RAM 1200. The CPU 1100 in the computer 1000 reads the program or the data (for example, the model 12e) from the recording medium 1800; however, as another example, the program may also be acquired from other devices via the network N.

### 6. Effects

As described above, the terminal device 10 detects the acceleration and acquires the feature value that is based on the acceleration. Then, the terminal device 10 estimates the speed based on the limit value of the feature value. Because the speed is estimated by the limit value, even if the position information based on the GPS or the like is not able to be acquired, the terminal device 10 can acquire the speed information with high accuracy.

Furthermore, the terminal device 10 judges the limit value in the speed range measured based on the information on the feature value that is associated with the speed range. Then, the terminal device 10 estimates, based on the information on the limit value in each speed range, the speed at the time of the acquired feature value. For example, the terminal device 10 estimates, as the speed at the time of the acquired feature value, the speed that is judged based on the information on the limit value in each speed range and at which the value of the acquired feature value is set to the limit value. Because the speed is estimated by the limit value in each speed range, even if the position information is not able to be acquired by using the GPS, or the like, the terminal device 10 can acquire the speed information with high accuracy.

Furthermore, if a plurality of speeds at which the value of the acquired feature value is set to the limit value is present, the terminal device 10 estimates, as the speed at the time of the acquired feature value, the highest speed from among the plurality of speeds. Furthermore, if a plurality of speeds at which the value of the acquired feature value is set to the limit value is present, the terminal device 10 estimates, as the speed at the time of the acquired feature value, the highest speed from among the speeds lower than a predetermined threshold speed included in the plurality of speeds. If the estimated speed is used as the maximum speed, the terminal device 10 can more gently limit the estimated speed.

Furthermore, the terminal device 10 estimates the speed at the time of the acquired feature value as the maximum speed. At this time, if the maximum speed is lower than the predetermined threshold speed, the terminal device 10 limits the estimated speed to the maximum speed and, if the maximum speed is higher than the predetermined threshold speed, the terminal device 10 does not need to limit the estimated speed to the maximum speed. Furthermore, the predetermined threshold speed may also be the speed in the range from 20 km/h to 40 km/h. The terminal device 10 can increase the accuracy of the estimated speed by limiting the estimated speed to the maximum speed.

Furthermore, the terminal device 10 associates the speed range that is based on the position information judged from the positioning signal with the feature value. Then, the terminal device 10 estimates the speed by using, as the acquired feature value, the feature value acquired by the acquiring unit 24 when the terminal device 10 is not able to acquire the position information based on the positioning signal. The terminal device 10 can acquired speed information with high accuracy even in also the case in which the terminal device 10 is not able to acquire the position information that is based on the positioning signal.

Furthermore, the terminal device 10 sets the reference direction of the acceleration. Then, the terminal device 10 acquires, as the feature value, the value based on the acceleration in the reference direction or the value based on the acceleration in the vertical direction with respect to the reference direction. For example, the terminal device 10 acquires, as the feature value, at least one of the average value, the standard deviation, and the maximum value of the magnitude of the acceleration in the vertical direction with respect to the reference direction obtained in a predetermined period or a predetermined number of times. Alternatively, the terminal device 10 acquires, as the feature value, at least one of the standard deviation, the maximum value, and the minimum value of the magnitude of the acceleration in the reference direction obtained in the predetermined period or the predetermined number of times. If one of these values is used as the feature value, the limit value can be easily judged; therefore, the terminal device 10 can estimate the speed with high accuracy.

Furthermore, the terminal device 10 sets the reference direction based on the acceleration detected by the detecting unit 21. For example, the terminal device 10 sets, as the reference direction, the direction of the average vector of the acceleration detected by the detecting unit 21. By setting the reference direction, the terminal device 10 can estimate the speed with high accuracy even if the orientation of the moving object can be changed.

Furthermore, the terminal device 10 acquires, as the feature value, the average value, the standard deviation, or the maximum value of the magnitude of the acceleration in the vertical direction with respect to the reference direction obtained in the predetermined period or the predetermined number of times. Then, the terminal device 10 judges, based on the feature value associated with the speed range, the lower limit of the feature value in a predetermined speed range. Then, the terminal device 10 estimates, as the speed at the time of the acquired feature value, the speed that is judged based on the information on the lower limit in each speed range and at which the value of the acquired feature value is set to the lower limit. Consequently, the terminal device 10 can estimate the speed with high accuracy.

Furthermore, the terminal device 10 acquires, as the feature value, the standard deviation or the maximum value of the magnitude of the acceleration in the reference direction obtained in the predetermined period or the predetermined number of times. Then, the terminal device 10 judges, based on the feature value associated with the speed range, the lower limit of the feature value in the predetermined speed range. Then, the terminal device 10 estimates, as the speed at the time of the acquired feature value, the speed that is judged based on the information on the lower limit in each speed range and at which the value of the acquired feature value is set to the lower limit. Consequently, the terminal device 10 can estimate the speed with high accuracy.

Furthermore, the terminal device 10 acquires, as the feature value, the minimum value of the magnitude of the acceleration in the reference direction obtained in the predetermined period or the predetermined number of times. Then, the terminal device 10 judges, based on the feature value associated with the speed range, the upper limit of the feature value in the predetermined speed range. Then, the terminal device 10 estimates, as the speed at the time of the acquired feature value, the speed that is judged based on the information on the upper limit in each speed range and at which the value of the acquired feature value is set to the upper limit. Consequently, the terminal device 10 can estimate the speed with high accuracy.

Furthermore, the reference direction may also be the direction of gravitational force or the direction of the average vector of the acceleration detected by the terminal device 10. Consequently, the terminal device 10 can estimate the speed with high accuracy.

In the above, embodiments of the present application have been described in detail based on the drawings; however the embodiments are described only by way of an example. In addition to the embodiments described in the detailed description, the present embodiments can be implemented in a mode in which various modifications and changes are made in accordance with the knowledge of those skilled in the art.

Furthermore, the “components (sections, modules, units)” described above can be read as “means”, “circuits”, or the like. For example, a moving state estimation unit can be read as a moving state estimation means or a moving state estimation circuit.

According to an aspect of an embodiment, it is possible to acquire speed information with high accuracy.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An estimation device comprising:
a detecting unit that detects acceleration;
an acquiring unit that acquires a feature value that is based on the acceleration; and
an estimation unit that estimates a speed based on a limit value of the feature value.

2. The estimation device according to claim 1, further comprising a judgement unit that judges the limit value in a speed range measured based on information on the feature value that is associated with the speed range, wherein
the estimation unit estimates, based on information on the limit value in each speed range, the speed at the time of the acquired feature value.

3. The estimation device according to claim 2, wherein the estimation unit estimates, as the speed at the time of the acquired feature value, the speed that is judged based on the information on the limit value in each speed range and at which the value of the acquired feature value is set to the limit value.

4. The estimation device according to claim 3, wherein, when a plurality of speeds at which the value of the acquired feature value is set to the limit value is present, the estimation unit estimates, as the speed at the time of the acquired feature value, the highest speed from among the plurality of speeds.

5. The estimation device according to claim 3, wherein, when a plurality of speeds at which the value of the acquired feature value is set to the limit value is present, the estimation unit estimates, as the speed at the time of the acquired feature value, the highest speed from among the speeds lower than a predetermined threshold speed included in the plurality of speeds.

6. The estimation device according to claim 2, wherein the estimation unit estimates the speed at the time of the acquired feature value as the maximum speed.

7. The estimation device according to claim 6, wherein, when the maximum speed is lower than the predetermined threshold speed, the estimation unit limits the estimated speed to the maximum speed and, when the maximum speed is higher than the predetermined threshold speed, the estimation unit does not limit the estimated speed to the maximum speed.

8. The estimation device according to claim 5, wherein the predetermined threshold speed is a speed selected from the speeds equal to or less than 40 km/h.

9. The estimation device according to claim 7, wherein the predetermined threshold speed is a speed selected from the speeds equal to or less than 40 km/h.

10. The estimation device according to claim 2, further comprising an associating unit that associates the speed range that is based on position information judged from a positioning signal with the feature value, wherein
the estimation unit estimates the speed by using, as the acquired feature value, the feature value acquired by the acquiring unit when the position information based on the positioning signal is not able to be acquired.

11. The estimation device according to claim 1, further comprising a setting unit that sets the reference direction of the acceleration, wherein
the acquiring unit acquires, as the feature value, a value based on the acceleration in the reference direction or a value based on the acceleration in the vertical direction with respect to the reference direction.

12. The estimation device according to claim 11, wherein the acquiring unit acquires, as the feature value, at least one of an average value, a standard deviation, and the maximum value of the magnitude of the acceleration in the vertical direction with respect to the reference direction obtained in a predetermined period or a predetermined number of times.

13. The estimation device according to claim 11, wherein the acquiring unit acquires, as the feature value, at least one of a standard deviation, the maximum value, and the minimum value of the magnitude of the acceleration in the reference direction obtained in the predetermined period or a predetermined number of times.

14. The estimation device according to claim 11, wherein the setting unit sets the reference direction based on the acceleration detected by the detecting unit.

15. The estimation device according to claim 14, wherein the setting unit sets, as the reference direction, the direction of an average vector of the acceleration detected by the detecting unit.

16. The estimation device according to claim 2, wherein
the acquiring unit acquires, as the feature value, an average value, a standard deviation, or the maximum value of the magnitude of the acceleration in the vertical direction with respect to the reference direction obtained in a predetermined period or a predetermined number of times,
the judgement unit judges, based on the feature value associated with the speed range, the lower limit of the feature value in a predetermined speed range, and
the estimation unit estimates, as the speed at the time of the acquired feature value, the speed that is judged based on the information on the lower limit in each speed range and at which the value of the acquired feature value is set to the lower limit.

17. The estimation device according to claim 2, wherein
the acquiring unit acquires, as the feature value, a standard deviation or the maximum value of the magnitude of the acceleration in the reference direction obtained in the predetermined period or the predetermined number of times,
the judgement unit judges, based on the feature value associated with the speed range, the lower limit of the feature value in a predetermined speed range, and
the estimation unit estimates, as the speed at the time of the acquired feature value, the speed that is judged based on the information on the lower limit in each speed range and at which the value of the acquired feature value is set to the lower limit.

18. The estimation device according to claim 2, wherein
the acquiring unit acquires, as the feature value, the minimum value of the magnitude of the acceleration in the reference direction obtained in a predetermined period or a predetermined number of times,
the judgement unit judges, based on the feature value associated with the speed range, the upper limit of the feature value in a predetermined speed range, and
the estimation unit estimates, as the speed at the time of the acquired feature value, the speed that is judged based on the information on the upper limit in each speed range and at which the value of the acquired feature value is set to the upper limit.

19. The estimation device according to claim 16, wherein the reference direction is the direction of gravitational force or the direction of the average vector of the acceleration detected by the detecting unit.

20. The estimation device according to claim 17, wherein the reference direction is the direction of gravitational force or the direction of the average vector of the acceleration detected by the detecting unit.

21. The estimation device according to claim 18, wherein the reference direction is the direction of gravitational force or the direction of the average vector of the acceleration detected by the detecting unit.

22. An estimation method performed by an estimation device, the estimation method comprising:
detecting acceleration;
acquiring a feature value that is based on the acceleration; and
estimating a speed based on a limit value of the feature value.

23. A non-transitory computer-readable recording medium having stored therein an estimation program that causes a computer to execute a process comprising:
detecting acceleration;
acquiring a feature value that is based on the acceleration; and
estimating a speed based on a limit value of the feature value.
